(19) United States
(12) Patent Application Publication
(10) Pub. No.: US 2025/0036073 A1
(43) Pub. Date: Jan. 30, 2025

(54) ELECTROPHOTOGRAPHIC PHOTOSENSITIVE MEMBER, PROCESS CARTRIDGE, AND IMAGE FORMING APPARATUS

(71) Applicant: KYOCERA Document Solutions Inc., Osaka (JP)

(72) Inventors: Ryohei YAMASAKI, Osaka (JP); Tetsuya SENDA, Osaka (JP); Zuishin JO, Osaka (JP)

(73) Assignee: KYOCERA Document Solutions Inc., Osaka (JP)

(21) Appl. No.: 18/772,053

(22) Filed: Jul. 12, 2024

(30) Foreign Application Priority Data
Jul. 14, 2023 (JP) 2023-115971

(51) Int. Cl. G03G 21/18; G03G 5/05; G03G 5/06; G03G 5/09

(52) U.S. Cl. CPC G03G 21/1814; G03G 5/056; G03G 5/0592; G03G 5/06145; G03G 5/09

(57) ABSTRACT

An electrophotographic photosensitive member includes a conductive substrate and a photosensitive layer provided directly or indirectly on the conductive substrate. The photosensitive layer includes a charge generating layer and a charge transport layer. The charge transport layer contains a binder resin, a hole transport material, and a phthalocyanine pigment. The binder resin includes a specific polyarylate resin. The specific polyarylate resin includes a first repeating unit represented by general formula (1), a second repeating unit represented by chemical formula (2), a third repeating unit represented by chemical formula (3), and a fourth repeating unit represented by chemical formula (4).

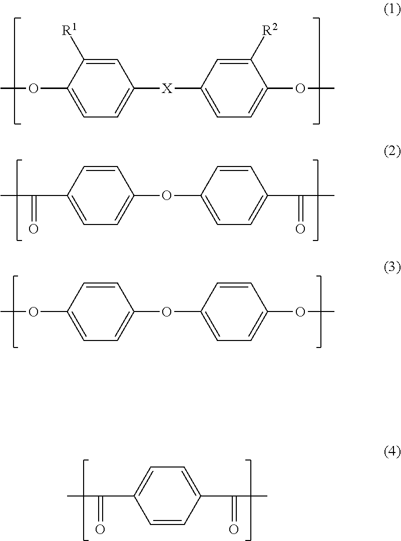

In general formula (1), X represents a divalent group with a carbon number of 1 to 10. R¹ and R² each represent, independently of one another, a hydrogen atom or an alkyl group with a carbon number of 1 to 6.

### INCORPORATION BY REFERENCE

The present application claims priority under 35 U.S.C. § 119 to Japanese Patent Application No. 2023-115971, filed on Jul. 14, 2023. The contents of this application are incorporated herein by reference in their entirety.

### BACKGROUND

The present disclosure relates to an electrophotographic photosensitive member, a process cartridge, and an image forming apparatus.

Electrophotographic photosensitive members are required to have excellent sensitivity characteristics, abrasion resistance, and preservability and be able to inhibit occurrence of image memory and fogging. To address these requirements, an electrophotographic photosensitive member is proposed including a surface layer to which a polyarylate resin is added.

### SUMMARY

An electrophotographic photosensitive member according to an aspect of the present disclosure includes a conductive substrate and a photosensitive layer provided directly or indirectly on the conductive substrate. The photosensitive layer includes a charge generating layer and a charge transport layer. The charge transport layer contains a binder resin, a hole transport material, and a phthalocyanine pigment. The binder resin includes a specific polyarylate resin. The specific polyarylate resin includes a first repeating unit represented by following general formula (1), a second repeating unit represented by following chemical formula (2), a third repeating unit represented by following chemical formula (3), and a fourth repeating unit represented by following chemical formula (4). A rate of a number of moles of the third repeating unit to a total number of moles of the first repeating unit and the third repeating unit is greater than 0.0% by mole and less than 50.0% by mole. A rate of a number of moles of the fourth repeating unit to a total number of moles of the second repeating unit and the fourth repeating unit is at least 30.0% by mole and less than 70.0% by mole.

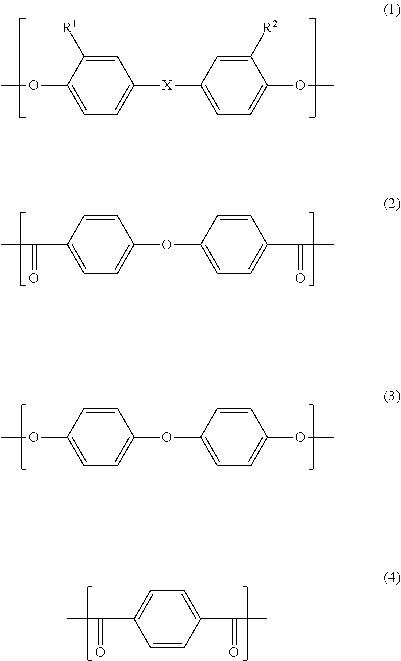

In the general formula (1), X represents a divalent group with a carbon number of at least 1 and no greater than 10. R¹ and R² each represent, independently of one another, a hydrogen atom or an alkyl group with a carbon number of at least 1 and no greater than 6.

A process cartridge according to another aspect of the present disclosure includes the above-described electrophotographic photosensitive member.

An image forming apparatus according to still another aspect of the present disclosure includes an image bearing member, a charger that charges a surface of the image bearing member, a light exposure device that exposes the charged surface of the image bearing member to light to form an electrostatic latent image on the surface of the image bearing member, a development device that develops the electrostatic latent image into a toner image by supplying toner to the surface of the image bearing member, and a transfer device that transfers the toner image from the image bearing member to a transfer target. The image bearing member is the above-described electrophotographic photosensitive member.

### BRIEF DESCRIPTION OF THE DRAWINGS

FIG. 1 is a partial cross-sectional view of an example of an electrophotographic photosensitive member according to a first embodiment of the present disclosure.

FIG. 2 is a partial cross-sectional view of another example of the electrophotographic photosensitive member according to the first embodiment.

FIG. 3 is a diagram illustrating an example of an image forming apparatus according to a second embodiment of the present disclosure.

### DETAILED DESCRIPTION

The following describes embodiments of the present disclosure in detail. However, the present disclosure is not limited to the following embodiments and can be practiced with alterations made as appropriate within a scope of objects of the present disclosure.

The term “(meth)acryl” is used as a generic term for both acryl and methacryl. The term “(meth)acrylate” is used as a generic term for both acrylate and methacrylate. Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter is a number average value of equivalent circle diameters of 100 primary particles, for example. Values for viscosity average molecular weights of resins are values as measured in accordance with the Japanese Industrial Standards (JIS) K7252-1:2016. The term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. The phrase “each represent, independently of one another,” in description about general formulas means possibly representing the same group or different groups. One type of each component described in the present specification may be used independently, or two or more types of the component may be used in combination. For example, the phrases “at least one of A, B, and C” and “at least one among A, B, and C” define the same as “at least one selected from the group consisting of A, B, and C”.

### First Embodiment: Electrophotographic Photosensitive Member

A first embodiment of the present disclosure relates to an electrophotographic photosensitive member (also referred to below as photosensitive member). The photosensitive member of the present embodiment includes a conductive substrate and a photosensitive layer provided directly or indirectly on the conductive substrate. The photosensitive layer includes a charge generating layer and a charge transport layer. The charge transport layer contains a binder resin, a hole transport material, and a phthalocyanine pigment. The binder resin includes a specific polyarylate resin. The specific polyarylate resin includes a first repeating unit represented by the following general formula (1), a second repeating unit represented by the following chemical formula (2), a third repeating unit represented by the following chemical formula (3), and a fourth repeating unit represented by the following chemical formula (4). The rate (also referred to below as rate (3)) of the number of moles of the third repeating unit to the total number of moles of the first repeating unit and the third repeating unit is greater than 0.0% by mole and less than 50.0% by mole. The rate (also referred to below as rate (4)) of the number of moles of the fourth repeating unit to the total number of moles of the second repeating unit and the fourth repeating unit is at least 30.0% by mole and less than 70.0% by mole.

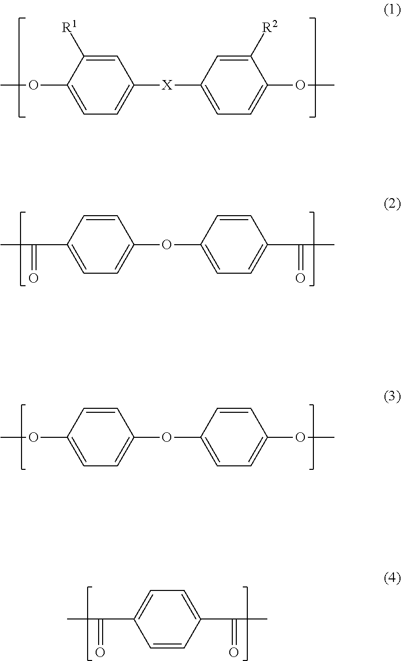

In general formula (1), X represents a divalent group with a carbon number of at least 1 and no greater than 10. R¹ and R² each represent, independently of one another, a hydrogen atom or an alkyl group with a carbon number of at least 1 and no greater than 6.

As a result of having the above features, the photosensitive member of the present disclosure can have excellent sensitivity characteristics, abrasion resistance, and preservability and be able to inhibit occurrence of image memory and fogging. The reasons thereof are inferred as follows. The charge transport layer of the photosensitive member of the present embodiment contains a specific polyarylate resin. The specific polyarylate resin includes the first repeating unit to the fourth repeating unit. The first repeating unit imparts rigidity to the specific polyarylate resin. The second repeating unit and third repeating unit impart flexibility to the specific polyarylate resin. The fourth repeating unit adjusts the balance of physical properties of the specific polyarylate resin. The specific polyarylate resin, which includes the first repeating unit to the fourth repeating unit with the ratios (3) and (4) set within the specific ranges, can impart excellent sensitivity characteristics, abrasion resistance, and preservability to the photosensitive member of the present embodiment. In particular, as a result of the rate (3) of the third repeating unit being set to greater than 0.0% by mole, the specific polyarylate resin can impart excellent abrasion resistance to the photosensitive member of the present embodiment. As a result of the rate (3) of the third repeating unit being set to less than 50.0% by mole, the specific polyarylate resin can inhibit gelation of an application liquid prepared in formation of the charge transport layer. As a result of the rate (4) of the fourth repeating unit being set to at least 30.0% by mole, the specific polyarylate resin can impart excellent preservability to the photosensitive member of the present embodiment. In addition, as a result of the rate (4) of the fourth repeating unit being set to less than 70.0% by mole, the specific polyarylate resin can impart excellent abrasion resistance to the photosensitive member of the present embodiment.

By contrast, in a known photosensitive member containing a polyarylate resin as a binder resin of a charge transport layer, charge tends to accumulate in the charge transport layer. Charge accumulation in the charge transport layer of the known photosensitive member serves as a cause of image memory and fogging. To address the above, the charge transport layer of the photosensitive member of the present embodiment contains a phthalocyanine pigment. Pigments can cancel charges accumulated in the charge transport layer to inhibit occurrence of fogging. Among the pigments, a phthalocyanine pigment can effectively cancel charges accumulated in the charge transport layer to inhibit occurrence of image memory in addition to fogging. As a result of the charge transport layer containing a phthalocyanine pigment, the photosensitive member of the present embodiment can inhibit occurrence of image memory and fogging. The photosensitive member is further described below.

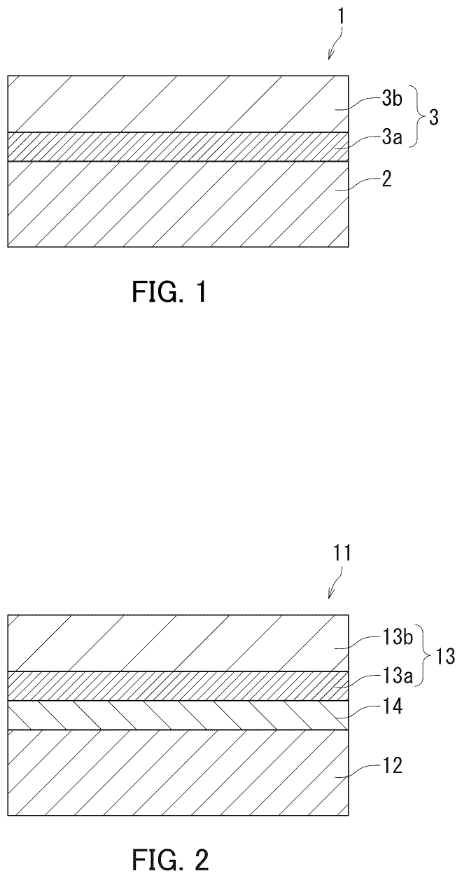

The photosensitive member of the present embodiment is a photosensitive member including a negatively-chargeable multi-layer photosensitive layer, for example. With reference to FIG. 1, the structure of a photosensitive member 1, which is an example of the photosensitive member of the present embodiment, is described below. FIG. 1 is a partial cross-sectional view of the photosensitive member 1. As illustrated in FIG. 1, the photosensitive member 1 includes a conductive substrate 2 and a photosensitive layer 3, for example. The photosensitive layer 3 includes a charge generating layer 3a and a charge transport layer 3b. That is, the photosensitive member 1 includes a conductive substrate 2, a charge generating layer 3a provided on the conductive substrate 2, and a charge transport layer 3b provided on the charge generating layer 3a.

The thickness of the charge generating layer 3a is preferably, but is not limited to, at least 0.01 μm and no greater than 5 μm, and more preferably at least 0.1 μm and no greater than 3 μm. In the example illustrated in FIG. 1, the charge generating layer 3a has a single layer structure. However, the charge generating layer 3a may have a multi-layer structure.

The thickness of the charge transport layer 3b is preferably, but is not limited to, at least 2 μm and no greater than 100 μm, and more preferably at least 5 μm and no greater than 50 μm. In the example illustrated in FIG. 1, the charge transport layer 3b has a single layer structure. However, the charge transport layer 3b may have a multi-layer structure. The structure of the photosensitive member 1, which is an example of the photosensitive member of the present embodiment, has been described so far with reference to FIG. 1.

With reference to FIG. 2, the structure of a photosensitive member 11, which is another example of the photosensitive member of the present embodiment, is described next. FIG. 2 is a partial cross-sectional view of the photosensitive member 11. As illustrated in FIG. 2, the photosensitive member 11 includes a conductive substrate 12, an intermediate layer 14, and a photosensitive layer 13, for example. The photosensitive layer 13 includes a charge generating layer 13a and a charge transport layer 13b. That is, the photosensitive member 11 illustrated in FIG. 2 includes a conductive substrate 12, an intermediate layer 14 provided on the conductive substrate 12, a charge generating layer 13a provided on the intermediate layer 14, and a charge transport layer 13b provided on the charge generating layer 13a.

The thickness of the intermediate layer 14 is preferably, but is not limited to, at least 1.0 μm and no greater than 20.0 μm, and more preferably at least 1.0 μm and no greater than 5.0 km.

The conductive substrate 12, the photosensitive layer 13, the charge generating layer 13a, and the charge transport layer 13b included in the photosensitive member 11 illustrated in FIG. 2 are respectively the same as the conductive substrate 2, the photosensitive layer 3, the charge generating layer 3a, and the charge transport layer 3b included in the photosensitive member 1 illustrated in FIG. 1. Therefore, description thereof is omitted.

The structure of the photosensitive member 1, which is an example of the photosensitive member of the present embodiment, and the structure of the photosensitive member 11, which is another example thereof” have been described so far with reference to FIGS. 1 and 2. However, the structure of the photosensitive member of the present embodiment may differ from those illustrated in FIGS. 1 and 2. Note that the charge transport layer preferably serves as the outermost surface layer of the photosensitive member of the present embodiment. As a result of the charge transport layer serving as the outermost surface layer, the charge transport layer of the photosensitive member of the present embodiment can exhibit excellent abrasion resistance to the most due to presence of the specific polyarylate resin. However, the charge transport layer may not serve as the outermost surface layer in the photosensitive member of the present embodiment. For example, the photosensitive member of the present embodiment may further include a protective layer provided on the photosensitive layer. The photosensitive member of the present embodiment having the above features can exhibit excellent abrasion resistance even when a protective layer is further included. This is because the charge transport layer, which contains the specific polyarylate resin, can have excellent abrasion resistance when the charge transport layer is exposed as a result of abrasion of the protective layer. In addition, the photosensitive member of the present embodiment may further include another layer besides the intermediate layer, the photosensitive layer, and the protective layer.

### [Conductive Substrate]

No particular limitations are placed on the conductive substrate so long as at least a surface portion of the conductive substrate is constituted by a conductive material. An example of the conductive substrate is a conductive substrate constituted by a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, and indium. Two or more conductive materials may be combined for use as an alloy (specific examples include aluminum alloy, stainless steel, or brass). In terms of favorable charge mobility from the photosensitive layer to the conductive substrate, the conductive material is preferably aluminum or aluminum alloy. The shape of the conductive substrate is appropriately selected according to the configuration of an image forming apparatus including the conductive substrate. The conductive substrate may be sheet-shaped or drum-shaped, for example. The thickness of the conductive substrate is appropriately selected according to the shape of the conductive substrate.

### [Photosensitive Layer]

The photosensitive layer is provided directly on the conductive substrate or provided indirectly on the conductive substrate with another layer (e.g., an intermediate layer) therebetween. The photosensitive layer includes a charge generating layer and a charge transport layer.

### [Charge Generating Layer]

The charge generating layer contains a charge generating material. The charge generating layer may further contain a binder resin for charge generating layer use (also referred to below as “base resin”). The charge generating layer may further contain an additive as necessary.

### (Charge Generating Material)

Examples of the charge generating material include phthalocyanine pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (e.g., selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, and pyrazoline-based pigments.

The phthalocyanine pigments have a phthalocyanine structure. Examples of the phthalocyanine pigments include metal phthalocyanines and metal-free phthalocyanine. Examples of the metal phthalocyanines include titanyl phthalocyanine, hydroxygallium phthalocyanine, and chlorogallium phthalocyanine. Titanyl phthalocyanine is preferable as a metal phthalocyanine. Titanyl phthalocyanine is represented by chemical formula (CG-1). Metal-free phthalocyanine is represented by chemical formula (CG-2).

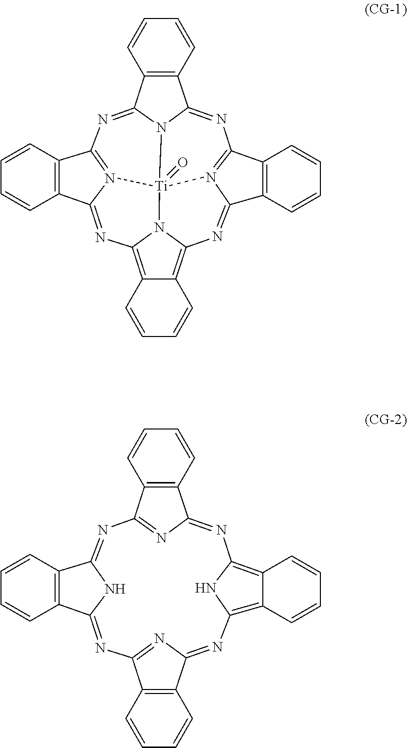

The phthalocyanine pigment may be crystalline or non-crystalline. An example of crystalline metal-free phthalocyanine is metal-free phthalocyanine having an X-form crystal structure (also referred to below as X-form metal-free phthalocyanine). Examples of the crystalline titanyl phthalocyanine include titanyl phthalocyanine having an α-form crystal structure, titanyl phthalocyanine having a β-form crystal structure, and titanyl phthalocyanine having a Y-form crystal structure (also referred to below as α-form titanyl phthalocyanine, β-form titanyl phthalocyanine, and Y-form titanyl phthalocyanine, respectively).

For example, a photosensitive member with a sensitivity in a wavelength range of at least 700 nm is preferably used in digital optical image forming apparatuses (e.g., laser beam printers or facsimile machines using a light source such as semiconductor laser). In terms of exhibiting high quantum yield in a wavelength range of at least 700 nm, the charge generating material is preferably a phthalocyanine pigment, more preferably titanyl phthalocyanine, and further preferably Y-form titanyl phthalocyanine.

Y-form titanyl phthalocyanine exhibits a main peak for example at a Bragg angle (2θ±0.2°) of 27.2° in a CuKα characteristic X-ray diffraction spectrum. The term main peak refers to a peak that is the most intense or second most intense peak within a range of Bragg angle (2θ±0.2°) between 3° and 40° in a CuKα characteristic X-ray diffraction spectrum. Y-form titanyl phthalocyanine does not exhibit a peak at 26.2° in the CuKα characteristic X-ray diffraction spectrum.

The CuKα characteristic X-ray diffraction spectrum can be plotted by the following method, for example. First, a sample (titanyl phthalocyanine) is loaded into a sample holder of an X-ray diffractometer (e.g., “RINT (registered Japanese trademark) 1100”, product of Rigaku Corporation) and then an X-ray diffraction spectrum is plotted under conditions of use of an X-ray tube made from Cu, a tube voltage of 40 kV, a tube current of 30 mA, and a wavelength of the CuKα characteristic X-ray of 1.542 Å. The measurement range (2θ) is for example from 3° to 40° (start angle: 3°, stop angle: 40°), and the scanning speed is for example 10°/min. The main peak is determined from the plotted X-ray diffraction spectrum and the Bragg angle of the main peak is read.

The charge generating material has a content of at least 0.1 parts by mass and no greater than 10.0 parts by mass relative to 100 parts by mass of the base resin in the charge generating layer, and more preferably at least 1.0 part by mass and no greater than 4.0 parts by mass.

### (Base Resin)

Examples of the base resin include thermoplastic resins, thermosetting resins, and photocurable resins. Examples of the thermoplastic resins include polycarbonate resin, polyarylate resin, styrene-butadiene copolymers, styrene-acrylonitrile copolymers, styrene-maleic acid copolymers, acrylic acid polymers, styrene-acrylic acid copolymers, polyethylene resin, ethylene-vinyl acetate copolymers, chlorinated polyethylene resin, polyvinyl chloride resin, polypropylene resin, ionomer resin, vinyl chloride-vinyl acetate copolymers, alkyd resin, polyamide resin, urethane resin, polysulfone resin, diallyl phthalate resin, ketone resin, polyvinyl butyral resin, polyester resin, polyvinyl acetal resin, and polyether resin. Examples of the thermosetting resins include silicone resin, epoxy resin, phenolic resin, urea resin, and melamine resin. Examples of the photocurable resins include acrylic acid adducts of epoxy compounds and acrylic acid adducts of urethane compounds. The base resin is preferably polyvinyl acetal resin.

The base resin has a percentage content of preferably at least 10.0% by mass and no greater than 60.0% by mass in the charge generating layer, and more preferably at least 20.0% by mass and no greater than 40.0% by mass.

### (Additive)

Examples of the additive in the charge generating layer include antidegradants (e.g., an antioxidant, a radical scavenger, a singlet quencher, and ultraviolet absorbing agent), softeners, surface modifiers, extenders, thickeners, dispersion stabilizers, waxes, acceptor compounds (e.g., electron acceptor compounds), donors, surfactants, plasticizers, sensitizers, and leveling agents. Examples of the antioxidant include hindered phenol compounds, hindered amine compounds, thioether compounds, and phosphite compounds. Examples of the leveling agents include dimethyl silicone oil.

### [Charge Transport Layer]

The charge transport layer contains a binder resin, a hole transport material, and a phthalocyanine pigment. The charge generating layer may further contain an additive as necessary.

### (Binder Resin)

The binder resin includes a specific polyarylate resin. The binder resin may include a resin other than the specific polyarylate resin, but preferably contain only the specific polyarylate resin. The specific polyarylate resin has a percentage content of preferably at least 80% by mass in the binder resin, more preferably at least 90% by mass, and further preferably 100% by mass. The binder resin has a percentage content of preferably at least 50.0% by mass and no greater than 90.0% by mass in the charge transport layer, and more preferably at least 60.0% by mass and no greater than 75.0% by mass.

### (Specific Polyarylate Resin)

The specific polyarylate resin is a polymer of a dicarboxylic acid monomer and a bisphenol compound monomer, for example. The dicarboxylic acid monomer includes dicarboxylic acid or a dicarboxylic acid derivative (e.g., dicarboxylic acid dichloride, dicarboxylic acid dimethyl ester, dicarboxylic acid diethyl ester, or dicarboxylic acid anhydride). The bisphenol compound monomer includes a bisphenol compound or a bisphenol compound derivative (e.g., aromatic diacetate derived from a bisphenol compound). The ratio between the total number of moles of the repeating units derived from the dicarboxylic acid monomer and the total number of moles of the repeating units derived from the bisphenol compound monomer is almost 1:1 in the specific polyarylate resin.

The specific polyarylate resin includes a first repeating unit represented by general formula (1), a second repeating unit represented by chemical formula (2), a third repeating unit represented by chemical formula (3), and a fourth repeating unit represented by chemical formula (4). The specific polyarylate resin may further include a repeating unit besides the first repeating unit to the fourth repeating unit, but preferably includes only the first repeating unit to the fourth repeating unit. The total percentage content of the first repeating unit to the fourth repeating unit is preferably at least 80.0% by mole in all repeating units included in the specific polyarylate resin, more preferably at least 95.0% by mole, and further preferably 100.0% by mole.

### (First Repeating Unit)

The first repeating unit is represented by general formula (1). The first repeating unit has a percentage content of at least 20.0% by mole and no greater than 45.0% by mole in all the repeating units included in the specific polyarylate resin, and more preferably at least 35.0% by mole and no greater than 45.0% by mole. As a result of the percentage content of the first repeating unit being set to at least 20.0% by mole, the photosensitive member of the present embodiment can effectively inhibit gelation of the application liquid prepared in formation of the charge transport layer. As a result of the percentage content of the first repeating unit being set to no greater than 45.0% by mole, the photosensitive member of the present embodiment can exhibit further excellent abrasion resistance.

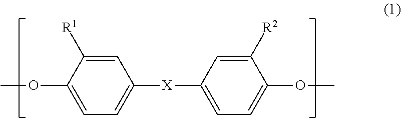

In general formula (1), X represents a divalent group with a carbon number of at least 1 and no greater than 10. R¹ and R² each represent, independently of one another, a hydrogen atom or an alkyl group with a carbon number of at least 1 and no greater than 6.

In general formula (1), the alkyl groups with a carbon number of at least 1 and no greater than 6 represented by R¹ and R² each are preferably a methyl group, an ethyl group, or a propyl group, and more preferably a methyl group. In general formula (1), R¹ and R² preferably represent the same group. More preferably, each represents a hydrogen atom or a methyl group.

In general formula (1), the divalent group with a carbon number of at least 1 and no greater than 10 represented by X is preferably an alkanediyl group with a carbon number of at least 2 and no greater than 5 or a cycloalkanediyl group with a carbon number of at least 5 and no greater than 7, and more preferably a group represented by chemical formula (X1) or (X2). In chemical formulas (X1) and (X2), * represents a bond.

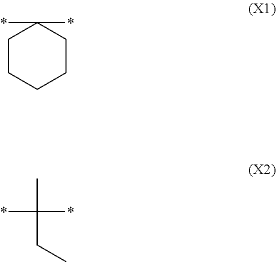

The first repeating unit is preferably represented by chemical formula (1-1) or (1-2).

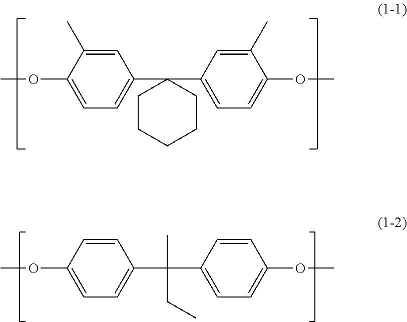

The first repeating unit derives from a compound represented by general formula (1a), for example. In general formula (1a), R¹, R², and X are as the same as defined in general formula (1).

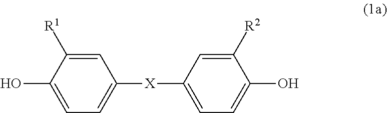

### (Second Repeating Unit)

The second repeating unit is represented by chemical formula (2). The second repeating unit has a percentage content of preferably at least 10.0% by mole and no greater than 40.0% by mole in all the repeating units included in the specific polyarylate resin, and more preferably at least 27.5% by mole and no greater than 37.5% by mole. As a result of the percentage content of the second repeating unit being set to at least 10.0% by mole, the photosensitive member of the present embodiment can exhibit further excellent abrasion resistance. As a result of the percentage content of the second repeating unit being set to no greater than 40.0% by mole, the photosensitive member of the present embodiment can further effectively inhibit occurrence of fogging while exhibiting further excellent preservability.

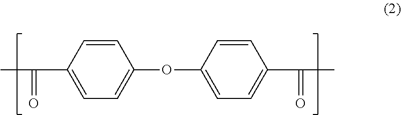

The second repeating unit is derived from 4,4′-oxybisbenzol chloride, for example.

### (Third Repeating Unit)

The third repeating unit is represented by chemical formula (3). The third repeating unit has a percentage content of preferably at least 5.0% by mole and no greater than 30.0% by mole in all the repeating units included in the specific polyarylate resin, and more preferably at least 5.0% by mole and no greater than 15.0% by mole. As a result of the percentage content of the third repeating unit being set to at least 5.0% by mole, the photosensitive member of the present embodiment can exhibit further excellent abrasion resistance. As a result of the percentage content of the third repeating unit being set to no greater than 30.0% by mole, gelation of the application liquid prepared in formation of the charge transport layer can be further effectively inhibited.

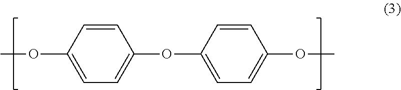

The third repeating unit derives from 4,4′-dihydroxydiphenyl ether, for example.

### (Fourth Repeating Unit)

The fourth repeating unit is represented by chemical formula (4). The fourth repeating unit has a percentage content of preferably at least 10.0% by mole and no greater than 40.0% by mole in all the repeating units included in the specific polyarylate resin, and more preferably at least 12.5% by mole and no greater than 22.5% by mole. As a result of the percentage content of the fourth repeating unit being set to at least 10.0% by mole, the photosensitive member of the present embodiment can further effectively inhibit occurrence of fogging while exhibiting further excellent preservability. As a result of the percentage content of the fourth repeating unit being set to no greater than 40.0% by mole, abrasion resistance of the photosensitive member of the present embodiment can be further optimized.

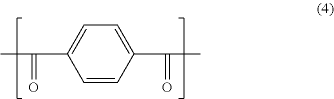

The fourth repeating unit is derived from terephthalic acid dichloride, for example.

The rate (3) of the number of moles of the third repeating unit to the total number of moles of the first repeating unit and the third repeating unit is greater than 0.0% by mole and less than 50.0% by mole in the specific polyarylate resin, preferably at least 5.0% by mole and no greater than 45.0% by mole, and more preferably at least 15.0% by mole and no greater than 25.0% by mole.

The rate (4) of the number of moles of the fourth repeating unit to the total number of moles of the second repeating unit and the fourth repeating unit is at least 30.0% by mole and less than 70.0% by mole in the specific polyarylate resin, preferably at least 30.0% by mole and no greater than 67.0% by mole, and further preferably at least 30.0% by mole and no greater than 40.0% by mole.

To all the repeating units included in the specific polyarylate resin, preferably: the first repeating unit has a percentage content of at least 20.0% by mole and no greater than 45.0% by mole; the second repeating unit has a percentage content of at least 10.0% by mole and no greater than 40.0% by mole; the third repeating unit has a percentage content of at least 5.0% by mole and no greater than 30.0% by mole; and the fourth repeating unit gas a percentage content of at least 10.0% by mole and no greater than 40.0% by mole.

The percentage content of each repeating unit in the specific polyarylate resin can be calculated from a ratio of the peaks unique to the respective repeating units in a ¹H-NMR spectrum of the specific polyarylate resin plotted using a proton nuclear magnetic resonance spectrometer.

The specific polyarylate resin may have an end group. Examples of the end group of the specific polyarylate resin include end groups represented by general formulas (T-1) and (T-2). The end group represented by general formula (T-1) is preferably an end group represented by chemical formula (T-DMP) (also referred to below as end group (T-DMP)). The end group represented by general formula (T-2) is preferably an end group represented by chemical formula (T-PFH) (also referred to below as end group (T-PFH)).

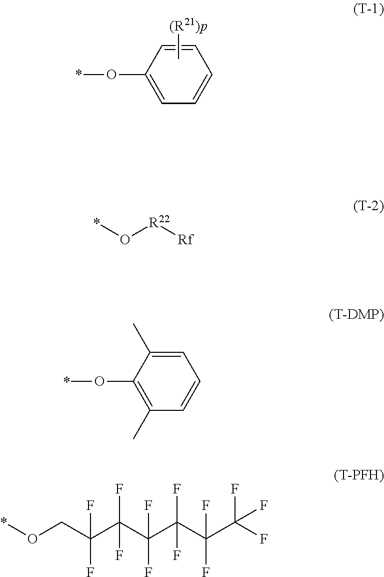

In general formula (T-1), R²¹ represents a halogen atom or an alkyl group with a carbon number of at least 1 and no greater than 6, and p represents an integer of at least 0 and no greater than 5. R²¹ preferably represents an alkyl group with a carbon number of at least 1 and no greater than 6, more preferably an alkyl group with a carbon number of at least 1 and no greater than 3, and further preferably a methyl group. P preferably represents an integer of at least 1 and no greater than 3, and more preferably represents 2.

In general formula (T-2), R²² represents an alkanediyl group with a carbon number of at least 1 and no greater than 6. Rf represents a perfluoroalkyl group with a carbon number of at least 1 and no greater than 10. R²² preferably represents an alkanediyl group with a carbon number of at least 1 and no greater than 3, and more preferably a methylene group. Rf preferably represents a perfluoroalkyl group with a carbon number of at least 3 and no greater than 10, more preferably a perfluoroalkyl group with a carbon number of at least 5 and no greater than 7, and further preferably a perfluoroalkyl group with a carbon number of 6.

In general formulas (T-1) and (T-2) and chemical formulas (T-DMP) and (T-PFH), * represents a bond. The bond represented by * in formulas general formulas (T-1) and (T-2) and chemical formulas (T-DMP) and (T-PFH) is bonded to a repeating unit (specifically, the second repeating unit or the fourth repeating unit) derived from the dicarboxylic acid monomer located at an end of the specific polyarylate resin.

In terms of improving filming resistance and scratch resistance of the photosensitive member of the present embodiment, the specific polyarylate resin preferably has an end group having a halogen atom.

One example of the end group having a halogen atom is an end group (T-1) where R²¹ in general formula (T-1) represents a halogen atom. Another example of the end group having a halogen atom is an end group (T-2).

In the specific polyarylate resin, the repeating units derived from the bisphenol compound monomer and the repeating units derived from the dicarboxylic acid monomer are adjacent to bond to each other. The specific polyarylate resin may be a random copolymer, an alternating copolymer, a periodic copolymer, or a block copolymer, for example.

The specific polyarylate resin is preferably any of polyarylate resins (a) to (d) shown in Table 1. In Table 1, the numerical ranges for the repeating units indicate the numerical ranges of the percentage contents of the respective repeating units to all the repeating units included in the corresponding polyarylate resins. The types “1-1” and “1-2” for the first repeating unit refer to repeating units represented by chemical formulas (1-1) and (1-2), respectively. For example, the polyarylate resin (a) includes a repeating unit represented by chemical formula (1-1) as the first repeating unit. To all repeating units included in the polyarylate resin (a): the first repeating unit has a percentage content of at least 75.0% by mole and no greater than 85.0% mole; the second repeating unit has a percentage content of at least 15.0% by mole and no greater than 25.0% by mole; the third repeating unit has a percentage content of at least 62.0% by mole and no greater than 68.0% by mole; and the fourth repeating unit has a percentage content of at least 32.0% by mole and no greater than 38.0% by mole. The polyarylate resins (a) to (d) may each further have any of the aforementioned end groups.

TABLE 1

| | First repeating | | Second | Third | Fourth |
|---|---|---|---|---|---|
| | unit | | repeating unit | repeating unit | repeating unit |
| | Type | % by mole | [% by mole] | [% by mole] | [% by mole] |
| a | 1-1 | 37.5-42.5 | 30.0-35.0 | 7.5-12.5 | 15.0-20.0 |
| b | 1-1 | 27.5-32.5 | 30.0-35.0 | 17.5-22.5 | 15.0-20.0 |
| c | 1-1 | 37.5-42.5 | 15.0-20.0 | 7.5-12.5 | 30.0-35.0 |
| d | 1-2 | 37.5-42.5 | 30.0-35.0 | 7.5-12.5 | 15.0-20.0 |

The specific polyarylate resin is particularly preferably any of resins represented by chemical formulas (pa-1) to (pa-4) (also referred to below as polyarylate resins (pa-1) to (pa-4), respectively). Note that the numbers located lower right of the repeating units in chemical formulas (pa-1) to (pa-4) indicate the percentage contents of the respective repeating units to all repeating units included in the corresponding polyarylate resins (pa-1) to (pa-4). The polyarylate resins (pa-1) to (pa-4) may further have any of the aforementioned end groups besides the repeating units represented by chemical formulas (pa-1) to (pa-4).

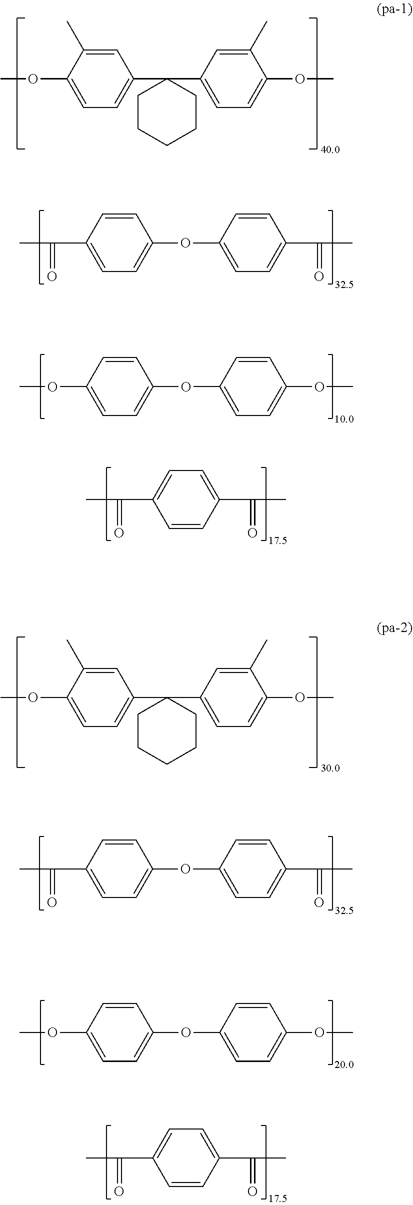

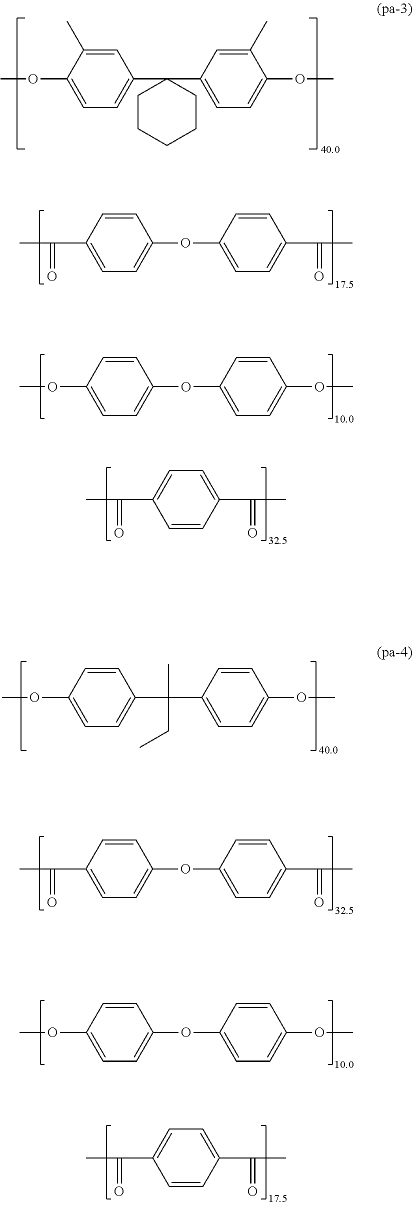

The specific polyarylate resin has a viscosity average molecular weight of preferably at least 10,000, more preferably at least 30,000, further preferably at least 35,000, and particularly preferably at least 50,000. As a result of the viscosity average molecular weight of the specific polyarylate resin being set to at least 10,000, abrasion resistance of the photosensitive member of the present embodiment can be further optimized. By contrast, the viscosity average molecular weight of the specific polyarylate resin is preferably no greater than 80,000, more preferably no greater than 70,000, and further preferably no greater than 60,000. As a result of the viscosity average molecular weight of the specific polyarylate resin being set to no greater than 80,000, solubility of the specific polyarylate resin in a solvent can be increased. The viscosity average molecular weight of the specific polyarylate resin is measured in accordance with the Japanese Industrial Standards (JIS) K7252-1:2016.

Description of a specific polyarylate resin production method is made next. The specific polyarylate resin production method may be condensation polymerization of a bisphenol compound monomer and a dicarboxylic acid monomer, for example. Any known synthesis method (e.g., solution polymerization, melt polymerization, or interface polymerization) can be employed as condensation polymerization. The bisphenol compound monomer includes a compound forming the first repeating unit and the third repeating unit. The dicarboxylic acid monomer includes a compound forming the second repeating unit and the fourth repeating unit.

In condensation polymerization of bisphenol and dicarboxylic acid, a terminator may be added. Examples of the terminator include 2,6-dimethylphenol and 1H,1H-perfluoro-1-heptanol. Use of 2,6-dimehtylphenol as a terminator forms the end group (T-DMP). Use of 1H,1H-perfluoro-1-heptanol as a terminator forms the end group (T-PFH).

In condensation polymerization of the bisphenol compound monomer and the dicarboxylic acid compound monomer, either or both a base and a catalyst may be added. An example of the base is sodium hydroxide. Examples of the catalyst include benzyltributylammonium chloride, ammonium chloride, ammonium bromide, quaternary ammonium salt, triethylamine, and trimethylamine.

### (Hole Transport Material)

Examples of the hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and a di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinyl carbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

Example of the hole transport material include compounds represented by general formulas (20), (23), (24), and (25) (also referred to below as hole transport materials (20), (23), (24), and (25), respectively).

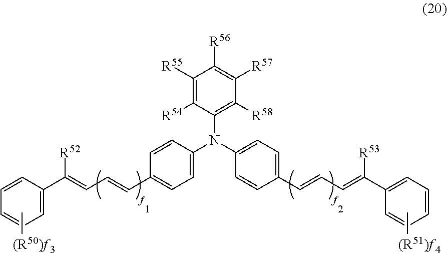

In general formula (20), R⁵⁰ and R⁵¹ each represent, independently of one another, a phenyl group, an alkyl group with a carbon number of at least 1 and no greater than 6, or an alkoxy group with a carbon number of at least 1 and no greater than 6. R⁵², R⁵³, R⁵⁴, R⁵⁵, R⁵⁶, R⁵⁷, and R⁵⁸ each represent, independently of one another, a hydrogen atom, a phenyl group optionally substituted with an alkyl group with a carbon number of at least 1 and no greater than 6, an alkyl group with a carbon number of at least 1 and no greater than 6, or an alkoxy group with a carbon number of at least 1 and no greater than 6. f₁ and f₂ each represent, independently of one another, an integer of at least 0 and no greater than 2. f₃ and f₄ each represent, independently of one another, an integer of at least 0 and no greater than 5.

In general formula (20), when f₃ represents an integer of at least 2 and no greater than 5, the chemical groups R⁵⁰ may represent the same group or different groups. When f₄ represents an integer of at least 2 and no greater than 5, the chemical groups R⁵¹ may represent the same group or different groups.

In general formula (20), preferably, R⁵⁰ and R⁵¹ each represent, independently of one another, an alkyl group with a carbon number of at least 1 and no greater than 3. Preferably, R⁵² and R⁵³ each represent, independently of one another, a hydrogen atom or a phenyl group optionally substituted with a methyl group. Preferably, R⁵⁴ to R⁵⁸ each represent, independently of one another, a hydrogen atom, an alkyl group with a carbon number of at least 1 and no greater than 4, or an alkoxy group with a carbon number of at least 1 and no greater than 3. Preferably, f₁ and f₂ each represent 0 or each represent 1. Preferably, f₃ and f₄ each represent, independently of one another, 0 or 1.

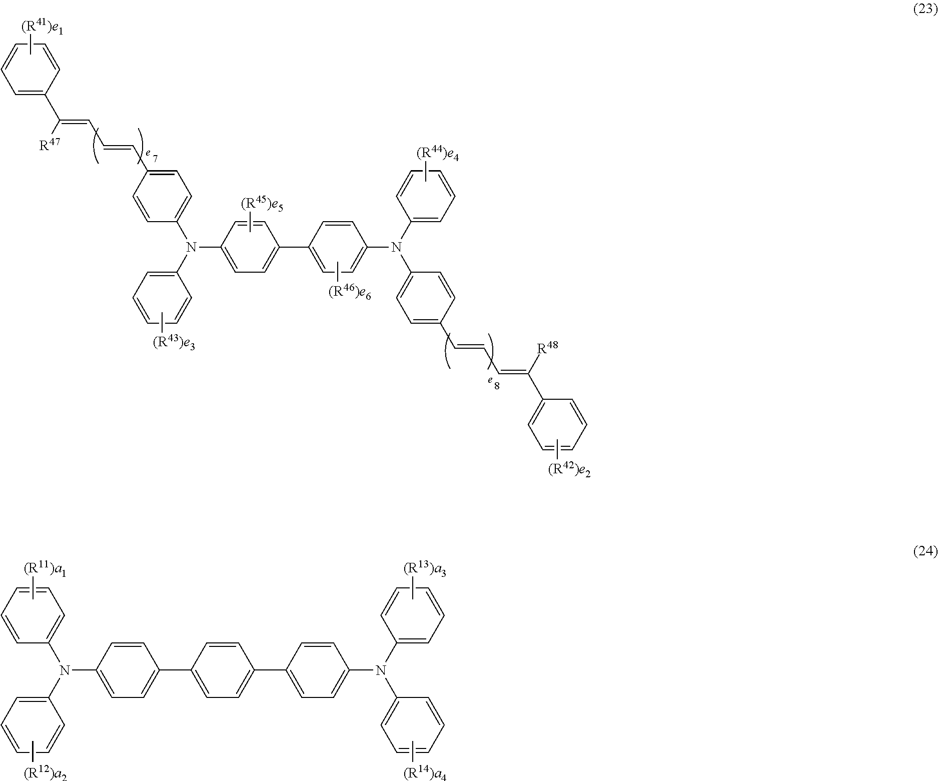

In general formula (23), R⁴¹, R⁴², R⁴³, R⁴⁴, R⁴⁵, and R⁴⁶ each represent, independently of one another, a phenyl group or an alkyl group with a carbon number of at least 1 and no greater than 6. R⁴⁷ and R⁴⁸ each represent, independently of one another, a hydrogen atom, a phenyl group, or an alkyl group with a carbon number of at least 1 and no greater than 6. e₁, e₂, e₃, and e₄ each represent, independently of one another, an integer of at least 0 and no greater than 5. e₅ and e₆ each represent, independently of one another, an integer of at least 0 and no greater than 4. e₇ and e₈ each represent, independently of one another, 0 or 1.

In general formula (23), when e₁ to e₆ each represent an integer of at least 2 and no greater than 4, the corresponding chemical groups R⁴¹ to R⁴⁶ may each represent the same group or different groups.

In general formula (23), preferably, R⁴¹ to R⁴⁶ each represent, independently of one another, an alkyl group with a carbon number of at least 1 and no greater than 3. Preferably, R⁴⁷ and R⁴⁸ each represent a hydrogen atom. Preferably, e₁, e₂, e₃, and e₆ each represent 0. Preferably, e₃ and e₄ each represent 2. Preferably, e₇ and e₈ each represent 0 or each represent 1.

In general formula (24), R¹¹, R¹², R¹³, and R¹⁴ each represent, independently of one another, an alkyl group with a carbon number of at least 1 and no greater than 6 or an alkoxy group with a carbon number of at least 1 and no greater than 6. a₁, a₂, a₃, and a₄ each represent, independently of one another, an integer of at least 0 and no greater than 5.

In general formula (24), when a₁ to a₄ each represent an integer of at least 2 and no greater than 5, the corresponding chemical groups R¹¹ to R¹⁴ may each represent the same group as or different groups.

In general formula (24), preferably, R¹¹, R¹², R¹³, and R¹⁴ each represent, independently of one another, an alkyl group with a carbon number of at least 1 and no greater than 3. Preferably, a₁, a₂, a₃, and a₄ each represent, independently of one another, 0 or 1.

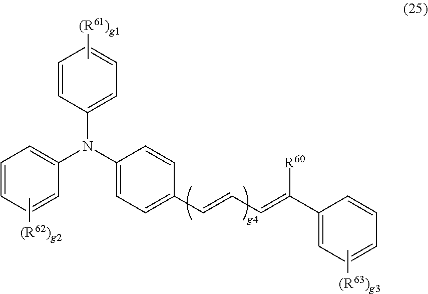

In general formula (25), R⁶⁰ represents a hydrogen atom, a phenyl group optionally substituted with an alkyl group with a carbon number of at least 1 and no greater than 8, an alkyl group with a carbon number of at least 1 and no greater than 8, or an alkoxy group with a carbon number of at least 1 and no greater than 8. R⁶¹, R⁶², and R⁶³ each represent, independently of one another, an alkyl group with a carbon number of at least 1 and no greater than 8 or an alkoxy group with a carbon number of at least 1 and no greater than 8. g1, g2, and g3 each represent, independently of one another, an integer of at least 0 and no greater than 5. g4 represents 0 or 1. Preferably, R⁶⁰ represents a phenyl group. Preferably, R⁶¹, R⁶² and R⁶³ each represent, independently of one another, an alkyl group with a carbon number of at least 1 and no greater than 3. Preferably, g1 and g2 each represent 1. Preferably, g3 represent 0.

In general formula (25), when g1 to g3 each represent an integer of at least 2 and no greater than 5, the corresponding chemical groups R⁶¹ R⁶³ may each represent the same group or different groups.

The hole transport material is preferably a compound represented by any of chemical formulas (H-1) to (H-5), general formula (H-6), and chemical formula (H-7) (also referred to below as hole transport materials (H-1) to (H-7), respectively).

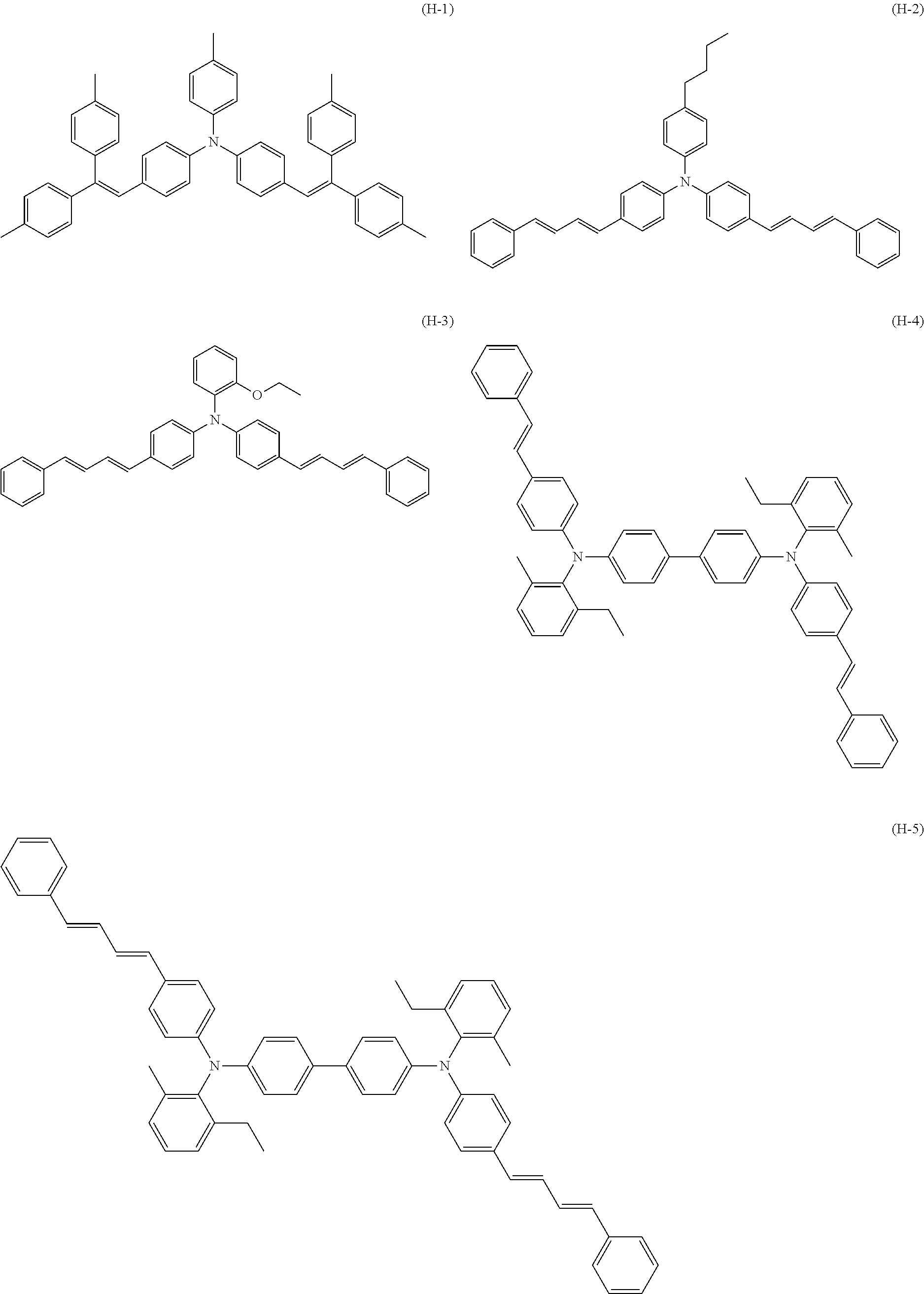

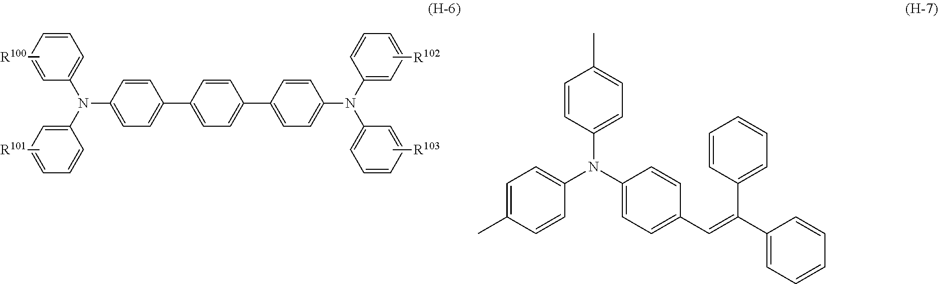

In general formula (H-6), R¹⁰⁰ to R¹⁰³ each represent, independently of one another, a hydrogen atom or a methyl group. However, at least two of R¹⁰⁰ to R¹⁰³ each represent a methyl group.

The hole transport material (H-6) is preferably a mixture (also referred to below as hole transport material (H-6 Mixture)) of a hole transport material (H-6a), a hole transport material (H-6b), and a hole transport material (H-6c). Here: the hole transport material (H-6a) is a compound in which two of R¹⁰⁰ to R¹⁰³ in general formula (H-6) each represent a methyl group and the other two each represent a hydrogen atom; the hole transport material (H-6b) is a compound in which three of R¹⁰⁰ to R¹⁰³ in general formula (H-6) each represent a methyl group and the other one represents a hydrogen atom; and the hole transport material (H-6c) is a compound in which all four of R¹⁰⁰ to R¹¹³ in general formula (H-6) each represent a methyl group.

The hole transport material may include at least one of the hole transport materials (20), (23), (24), or (25). The total percentage content of the hole transport materials (20) and (23) to (25) to the amount of the hole transport material is preferably at least 80% by mass, more preferably at least 90% by mass, and further preferably 100% by mass.

The hole transport material has a content of preferably at least 10 parts by mass and no greater than 200 parts by mass relative to 100 parts by mass of the binder resin in the charge transport layer, and more preferably at least 30 parts by mass and no greater than 60 parts by mass. As a result of the content of the hole transport material being set to at least 10 parts by mass and no greater than 200 parts by mass, the photosensitive member of the present embodiment can further effectively inhibit occurrence of fogging.

### (Phthalocyanine Pigment)

The phthalocyanine pigment contained in the charge transport layer has a phthalocyanine structure. Examples of the phthalocyanine pigment include the same compounds as those listed as the examples of the charge generating material contained in the charge generating layer. The phthalocyanine pigment contained in the charge transport layer is preferably metal-free phthalocyanine (compound represented by chemical formula (CG-2)) or a compound (metal phthalocyanine) represented by general formula (P-1), more preferably titanyl phthalocyanine, and further preferably Y-form titanyl phthalocyanine.

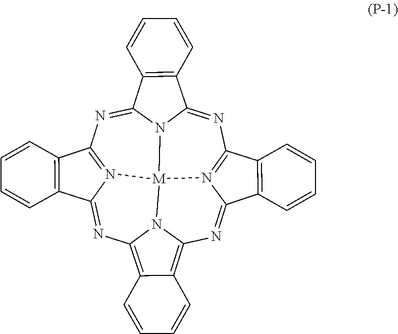

In general formula (P-1), M represents a metal atom optionally having a ligand. Preferably the metal atom represented by M is titanium optionally having a ligand.

The phthalocyanine pigment has a content of preferably at least 0.1 parts by mass and no greater than 0.5 parts by mass relative to 100.0 parts by mass of the binder resin in the charge transport layer, and more preferably at least 0.2 parts by mass and no greater than 0.4 parts by mass. As a result of the content of the phthalocyanine pigment being set to at least 0.1 parts by mass, the photosensitive member of the present embodiment can further effectively inhibit occurrence of image memory and fogging.

As a result of the content of the phthalocyanine pigment being set to no greater than 0.5 parts by mass, sensitivity characteristics of the photosensitive member of the present embodiment can be further optimized.

### (Additive)

Examples of the additive contained in the charge transport layer include a ultraviolet absorbing agent, an antioxidant, a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent. Examples of the leveling agent include silicone oils and a specific example is dimethyl silicone oil.

The charge transport layer preferably contains a silicone oil. In this case, the silicone oil preferably has a content of at least 0.01 parts by mass and no greater than 0.5 parts by mass relative to 100 parts by mass of the binder resin in the charge transport layer.

Preferably, the charge transport layer contains only the specific polyarylate resin, the hole transport material, the phthalocyanine pigment, and the additive (particularly, silicone oil). The total percentage content of the specific polyarylate resin, the hole transport material, the phthalocyanine pigment, and the additive (particularly, silicone oil) is preferably at least 90% by mass in the charge transport layer, and more preferably 100% by mass.

Table 2 shows preferable combinations, in the charge transport layer, of the type of the specific polyarylate resin, the type and amount of the hole transport material, and the type and amount of the phthalocyanine pigment. In Table 2, “Content” refers to a content [parts by mass] of a corresponding component relative to 100.0 parts by mass of the binder resin. The numerical ranges of the content indicate numerical ranges of the contents of the corresponding components. “K-1” and “K-2” under “Phthalocyanine pigment” refer to Y-form titanyl phthalocyanine and metal-free phthalocyanine, respectively. For example, the column titled “Combination 1” indicates that: the charge transport layer contains only the polyarylate resin (pa-1) as the binder resin, only the hole transport material (H-1) as the hole transport material, and only Y-form titanyl phthalocyanine pigment as the phthalocyanine pigment; the content of the hole transport material is at least 40.0 parts by mass and no greater than 50.0 parts by mass relative to 100.0 parts by mass of the binder resin; and the content of the phthalocyanine pigment is at least 0.05 parts by mass and no greater than 0.15 parts by mass relative to 100.0 parts by mass of the binder resin. In Combination 1, the charge transport layer may further contain an additive.

TABLE 2

| | Binder | | | | |
|---|---|---|---|---|---|
| | resin | Hole transport | | Phthalocyanine | |
| | Polyarylate | material | | pigment | |
| | resin | Type | Content | Type | Content |
| Combination 1 | pa-1 | H-1 | 40.0-50.0 | K-1 | 0.05-0.15 |
| Combination 2 | pa-1 | H-1 | 40.0-50.0 | K-1 | 0.2-0.4 |
| Combination 3 | pa-1 | H-1 | 40.0-50.0 | K-1 | 0.4-0.6 |
| Combination 4 | pa-1 | H-1 | 40.0-50.0 | K-2 | 0.2-0.4 |
| Combination 5 | pa-1 | H-2 | 40.0-50.0 | K-1 | 0.2-0.4 |
| Combination 6 | pa-1 | H-3 | 40.0-50.0 | K-1 | 0.2-0.4 |
| Combination 7 | pa-1 | H-4 | 40.0-50.0 | K-1 | 0.2-0.4 |
| Combination 8 | pa-1 | H-5 | 40.0-50.0 | K-1 | 0.2-0.4 |
| Combination 9 | pa-1 | H-6 | 40.0-50.0 | K-1 | 0.2-0.4 |
| | | Mixture | | | |
| Combination 10 | pa-1 | H-7 | 40.0-50.0 | K-1 | 0.2-0.4 |
| Combination 11 | pa-2 | H-1 | 40.0-50.0 | K-1 | 0.2-0.4 |
| Combination 12 | pa-3 | H-1 | 40.0-50.0 | K-1 | 0.2-0.4 |
| Combination 13 | pa-4 | H-1 | 40.0-50.0 | K-1 | 0.2-0.4 |

### [Intermediate Layer]

The intermediate layer is provided between the conductive substrate and the photosensitive layer. The intermediate layer contains an intermediate layer resin and inorganic particles, for example. Provision of the intermediate layer can facilitate flow of current generated when the photosensitive member of the present embodiment is exposed to light to inhibit increasing resistance, while also maintaining insulation to a sufficient degree so as to inhibit occurrence of leakage current.

Examples of the intermediate layer resin are the same as those listed as the examples of the base resin in the charge generating layer. The intermediate layer resin is preferably a polyamide resin, and more preferably a quaternary copolymer polyamide resin of nylon 6, nylon 12, nylon 66, and nylon 610.

The intermediate layer resin has a percentage content of preferably at least 20.0% by mass and no greater than 50.0% by mass in the intermediate layer, and more preferably at least 25.0% by mass and no greater than 40.0% by mass.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

The inorganic particles have a content of preferably at least 100 parts by mass and no greater than 300 parts by mass relative to 100 parts by mass of the intermediate layer resin in the intermediate layer, and more preferably at least 150 parts by mass and no greater than 250 parts by mass.

The intermediate layer may contain an additive. Examples of the additive contained in the intermediate layer are the same as those listed as the examples of the additive contained in the charge transport layer. However, the intermediate layer preferably contains only the intermediate layer resin and the inorganic particles. Specifically, the total percentage content of the intermediate layer resin and the inorganic particles is preferably at least 90% by mass in the intermediate layer, more preferably at least 99% by mass, and further preferably 100% by mass.

### [Photosensitive Member Production Method]

One example of a method for producing the photosensitive member of the present embodiment is described next. The photosensitive member production method includes a photosensitive layer formation process, for example. The photosensitive layer formation process includes a charge generating layer formation process and a charge transport layer formation process, for example. The photosensitive member production method may further include an intermediate layer formation process before the photosensitive layer formation process.

### (Intermediate Layer Formation Process)

In the intermediate layer formation process, an application liquid (also referred to below as application liquid for intermediate layer formation) for forming the intermediate layer is prepared. The application liquid for intermediate layer formation contains the intermediate layer resin, the organic particles, and a solvent, for example. Next, the application liquid for intermediate layer formation is applied onto the conductive substrate. Next, at least a portion of the solvent contained in the applied application liquid for intermediate layer formation is removed to form the intermediate layer.

### (Charge Generating Layer Formation Process)

In the charge generating layer formation process, an application liquid (also referred to below as application liquid for charge generating layer formation) for forming the charge generating layer is prepared. The application liquid for charge generating layer formation contains the charge generating material, the base resin, a solvent, and an optional component (e.g., the additive), for example. The application liquid for charge generating layer formation is prepared by mixing the above components. Next, the application liquid for charge generating layer formation is applied onto the conductive substrate or the intermediate layer. Next, at least a portion of the solvent contained in the applied application liquid for charge generating layer formation is removed to form the charge generating layer.

### (Charge Transport Layer Formation Process)

In the charge transport layer formation process, an application liquid (also referred to below as application liquid for charge transport layer formation) for forming the charge transport layer is prepared. The application liquid for charge transport layer formation contains the hole transport material, the binder resin, the phthalocyanine pigment, a solvent, and an optional component (e.g., the additive). The application liquid for charge transport layer formation is prepared by mixing the above components. Next, the application liquid for charge transport layer formation is applied onto the charge generating layer. Next, at least a portion of the solvent contained in the applied application liquid for charge transport layer formation is removed to form the charge transport layer.

No particular limitations are placed on the solvent contained in the application liquid for intermediate layer formation, the application liquid for charge generating layer formation, or the application liquid for charge transport layer formation (each also referred to below generally as application liquid) so long as the application liquid can dissolve or disperse the corresponding components contained therein. Examples of the solvents include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include methylene chloride, chloroform, ethylene chloride, dichloromethane, dichloroethane, carbon tetrachloride, and chlorobenzene), ethers (specific examples include dioxane, dimethyl ether, diethyl ether, tetrahydrofuran, ethylene glycol dimethyl ether, propylene glycol monomethyl ether, and diethylene glycol dimethyl ether), ketones (specific examples include acetone, methyl ethyl ketone, 2-butanone, and cyclohexanone), esters (specific examples include ethyl acetate and methyl acetate), dimethyl formaldehyde, dimethyl formamide, and dimethyl sulfoxide.

Each application liquid is prepared by mixing the corresponding components to dissolve or disperse the components in the corresponding solvent. Mixing can be performed using a bead mill, a ball mill, a roll mill, a paint shaker, or an ultrasonic disperser, for example.

No particular limitations are placed on a method for applying the application liquid so long as uniform application of the application liquid can be achieved. Examples of the application method include dip coating, spray coating, bead coating, blade coating, and roller coating.

Examples of a method for removing at least a portion of the solvent contained in the application liquid for intermediate layer formation, the application liquid for charge generating layer formation, or the application liquid for charge transport layer formation include heating, pressure reduction, and combination of heating and pressure reduction. A more specific example is heat treatment (hot air drying) using a high-temperature dryer or a vacuum dryer. The temperature for the heat treatment is at least 40° C. and no greater than 150° C., for example. The time for the heat treatment is at least 3 minutes and no greater than 150 minutes, for example.

### Second Embodiment: Image Forming Apparatus

A second embodiment of the present disclosure relates to an image forming apparatus. The image forming apparatus includes an image bearing member, a charger that charges the surface of the image bearing member, a light exposure device that exposes the charged surface of the image bearing member to light to form an electrostatic latent image on the surface of the image bearing member, a development device that develops the electrostatic latent image into a toner image by supplying toner to the surface of the image bearing member, and a transfer devices that transfers the toner image from the image bearing member to a transfer target. The image bearing member is the electrophotographic photosensitive member described in the second embodiment.

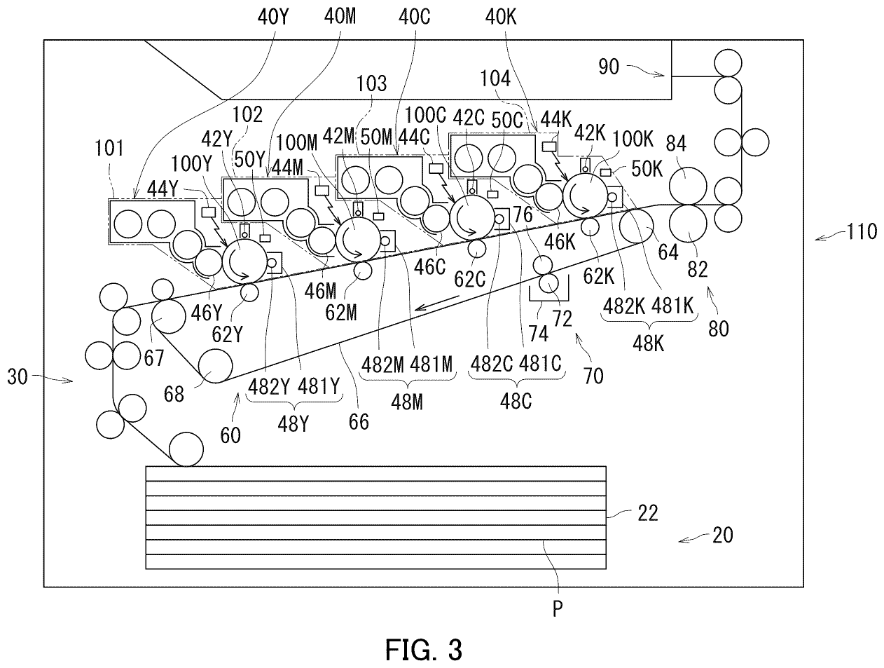

With reference to FIG. 3, an image forming apparatus 110 is described which one example of the image forming apparatus of the present embodiment. FIG. 3 is a diagram illustrating an example of the configuration of the image forming apparatus 110. The image forming apparatus 110 is a tandem color printer, for example.

The image forming apparatus 110 illustrated in FIG. 3 includes a feeding section 20, a conveyance section 30, image forming units 40Y, 40M, 40C, and 40K, a transfer section 60, and a belt cleaning section 70, a fixing section 80, and a sheet ejection section 90.

The image forming apparatus 110 may further include a controller. The controller controls operation of each element (specifically, the feeding section 20, the conveyance section 30, the image forming units 40Y, 40M, 40C, and 40K, the transfer section 60, the belt cleaning section 70, the fixing section 80, and the sheet ejection section 90)) of the image forming apparatus 110. The controller is placed at an appropriate location in the main body casing of the image forming apparatus 110. The controller includes a central processing unit (CPU), random access memory (RAM), read only memory (ROM), and an input and output interface, for example. The controller executes various arithmetic processing based on detection results from various sensors and preset programs to perform control.

The feeding section 20 includes a cassette 22. The cassette 22 accommodates a plurality of recording medium sheets P. The feeding section 20 feeds each of the recording medium sheets P from the cassette 22 to the conveyance section 30 one at a time. The recording medium sheets P are sheets of paper, cloth, or synthesized resin, for example.

The conveyance section 30 conveys the recording medium sheet P to the image forming units 40Y, 40M, 40C, and 40K.

The image forming units 40Y, 40M, 40C, and 40K respectively include image bearing members 100Y, 100M, 100C, and 100K, chargers 42Y, 42M, 42C, and 42K, light exposure devices 44Y, 44M, 44C, and 44K, development devices 46Y, 46M, 46C, and 46K, cleaners 48Y, 48M, 48C, and 48K, and static eliminators 50Y, 50M, 50C, and 50K. When there is no need to distinguish, the subscripts “Y”, “M”, “C”, and “K” attached to the reference members for the elements of the image forming apparatus 110 are omitted in the following. For example, when there is no need to distinguish, the image forming units 40Y, 40M, 40C, and 40K each are referred to as image forming unit 40.

The transfer section 60 includes four transfer devices 62Y, 62M, 62C, and 62K, a drive roller 64, an endless transfer belt 66, a driven roller 67, and a tension roller 68. The transfer devices 62Y, 62M, 62C, and 62K each are placed around the inner circumference of the transfer belt 66 to be opposite to the image bearing members 100Y, 100M, 100C, and 100K, respectively, with the transfer belt 66 therebetween. The transfer belt 66 is wound between the drive roller 64, the driven roller 67, and the tension roller 68. The transfer belt 66 circulates in an arrow direction (clockwise direction in FIG. 3.) by rotation of the drive roller 64.

With respect of each of the image forming units 40, the corresponding image bearing member 100 is placed at the central part of the image forming unit 40. The image bearing member 100 is placed in a rotatable manner in an arrow direction (anticlockwise direction in FIG. 3). The corresponding charger 42, the corresponding light exposure device 44, the corresponding development device 46, the corresponding transfer device 62, the corresponding cleaner 48, and the corresponding static eliminator 50 are placed around the image bearing member 100 in the stated order from upstream in terms of the rotation direction of the image bearing member 100.

The image bearing member 100 is the above-described photosensitive member (e.g., the photosensitive member 1 in FIG. 1).

The charger 42 charges the surface (e.g., the circumferential surface) of the image bearing member 100 to a positive polarity. The charger 42 is a scorotron charger, for example.

The light exposure device 44 exposes the charged surface of the image bearing member 100 to light. This forms an electrostatic latent image on the surface of the image bearing member 100. The electrostatic latent image is formed based on image data input to the image forming apparatus 110.

The development device 46 develops the electrostatic latent image into a toner image by supplying toner to the surface of the image bearing member 100. The toner is a positively chargeable toner. The development device 46 is in contact with the surface of the image bearing member 100. That is, the image forming apparatus 110 adopts the contact development process. The development device 46 is a development roller, for example.

Preferably, a developer used in the development device 46 is a one-component developer. In this case, the development device 46 supplies a toner being the one-component developer to the electrostatic latent image formed on the image bearing member 100. However, the developer may be a two-component developer. In this case, the development device 46 supplies the toner, which is part of the two-component developer containing toner and carrier, to the electrostatic latent image formed on the image bearing member 100. The image bearing member 100 bears the toner image formed by toner supply.

The transfer belt 66 conveys the recording medium sheet P between the image bearing member 100 and the transfer device 62. The transfer device 62 transfers the toner image developed by the development device 46 to the recording medium sheet P being a transfer target from the surface of the image bearing member 100. During transfer, the surface of the image bearing member 100 is in contact with the recording medium sheet P. That is, the image forming apparatus 110 adopts the direct transfer process. The transfer device 62 is a transfer roller, for example.

Toner images of a plurality of colors (e.g., four colors of yellow, magenta, cyan, and black) are sequentially superimposed on the recording medium sheet P on the transfer belt 66 by a pair of the image forming unit 40Y and the transfer device 62Y, a pair of the image forming unit 40M and the transfer device 62M, a pair of the image forming unit 40C and the transfer device 62C, and a pair of the image forming unit 40K and the transfer device 62K. Thus, unfixed toner image is formed.

The cleaners 48Y, 48M, 48C, and 48K respectively include housings 481Y, 481M, 481C, and 481K and cleaning members 482Y, 482M, 482C, and 482K. The cleaning members 482 are placed in the housings 481. The cleaning members 482 are in contact with the surfaces of the image bearing members 100. The cleaning members 482 polish the surfaces of the image bearing members 100 to collect toner attached to the surfaces of the image bearing members 100 into the housings 481. In the manner described above, the cleaners 48 collect toner attached to the surfaces of the image bearing members 100. The cleaning members 482 may each be a cleaning roller or a cleaning brush, for example.

The static eliminators 50 remove static on the surfaces of the image bearing members 100.

The recording medium sheet P with the unfixed toner image formed thereon is conveyed to the fixing section 80. The fixing section 80 includes a pressure member 82 and a heating member 84. The recording medium sheet P is pressed and heated by the pressure member 82 and the heating member 84 to fix the unfixed toner to the recording medium sheet P.

The recording medium sheet P with the toner image fixed thereto is ejected from the sheet ejection section 90.

One example of the image forming apparatus of the present embodiment has been described so far. However, the image forming apparatus of the above-described present disclosure is not limited to the image forming apparatus 110 and can be further altered as follows, for example. Although the image forming apparatus 110 is a color image forming apparatus, the image forming apparatus of the present embodiment may be a monochrome image forming apparatus. In this case, the image forming apparatus of the present embodiment only needs to include one image forming unit, for example. Although the above-described image forming apparatus 110 is a tandem image forming apparatus, the image forming apparatus of the present embodiment may be a rotary image forming apparatus, for example. Although the chargers 42 each are a scorotron charger as an example, the chargers may each be a charger (e.g., a charging roller, a charging brush, or a corotron charger) other than the scorotron charger. Although the above-described image forming apparatus 110 adopts the contact development process, the image forming apparatus may adopt the non-contact development process. Although the above-described image forming apparatus 110 adopts the direct transfer process, the image forming apparatus may adopt the intermediate transfer process. Note that the photosensitive member of a known image forming apparatus adopting the direct transfer process receives transfer damage during transfer of toner images from the photosensitive members to a recording medium. As a result, image memory and fogging tend to occur in the known image forming apparatus adopting the direct transfer process. By contrast, the image forming apparatus of the present embodiment, which includes the photosensitive members of the first embodiment, can effectively inhibit occurrence of image memory and fogging. The image forming apparatus of the present embodiment has been descried so far.

### Third Embodiment: Process Cartridge

A third embodiment of the present disclosure relates to a process cartridge. The process cartridge of the present embodiment includes the photosensitive member of the first embodiment.

With reference further to FIG. 3, a first process cartridge 101, a second process cartridge 102, a third process cartridge 103, and a fourth process cartridge 104 are described each of which is an example of the process cartridge of the present embodiment. The first process cartridge 101 to the fourth process cartridge 104 of the present embodiment respectively correspond to the image forming units 40Y, 40M, 40C, and 40K. Each of the first process cartridge 101 to the fourth process cartridge 104 includes the corresponding image bearing member 100Y, 100M, 100C, or 100K as the image bearing member 100. The image bearing member 100 is the photosensitive member of the first embodiment. As described in the first embodiment, the photosensitive member of the first embodiment can have excellent sensitivity characteristics, abrasion resistance, and preservability and be able to inhibit occurrence of image memory and fogging. Accordingly, the process cartridge of the present embodiment can have excellent sensitivity characteristics, abrasion resistance, and preservability and be able to inhibit occurrence of image memory and fogging.

The process cartridge of the present embodiment may further include at least one (e.g., at least 1 and no greater than 7) selected from the group consisting of the charger 42, the light exposure device 44, the development device 46, the transfer device 62, the cleaner 48 or the cleaning member 482, and the static eliminator 50.

Likewise the image forming units 40Y, 40M, 40C, and 40K, the first process cartridge 101, the second process cartridge 102, the third process cartridge 103, and the fourth process cartridge 104 illustrated in FIG. 3 respectively include: the image bearing members 100Y, 100M, 100C, and 100K each as the image bearing member 100; the chargers 42Y, 42M, 42C, and 42K each as the charger 42; the light exposure devices 44Y, 44M, 44C, and 44K each as the light exposure device 44; the development devices 46Y, 46M, 46C, and 46K each as the development device 46; the cleaners 48Y, 48M, 48C, and 48K each as the cleaner 46; and the static eliminators 50Y, 50M, 50C, and 50K each as the static eliminator 50. However, the process cartridge of the present embodiment is not limited to the first process cartridge 101 to the fourth process cartridge 104. As described above, the process cartridge of the present embodiment may further include a transfer device 62. In any case, the process cartridge of the present embodiment only needs to include the photosensitive member of the first embodiment as the image bearing member 100.

The process cartridge of the present embodiment is designed to be freely attachable to and detachable from the image forming apparatus 110. In the above configuration, the process cartridge is easy to handle and can be easily and quickly replaced with a new one including the image bearing member 100 when sensitivity characteristics or other attributes of the image bearing member 100 degrade. The process cartridge of the present embodiment has been described so far with reference to FIG. 3.

### [Substituents]

The following describes the substituents used in the present specification. Examples of the halogen atom (halogen group) include a fluorine atom (fluoro group), a chlorine atom (chloro group), a bromine atom (bromo group), and an iodine atom (iodo group).

The alkyl groups each are an unsubstituted straight chain or branched chain alkyl group unless otherwise stated. Examples of the alkyl group with a carbon number of at least 1 and no greater than 8 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ehtylpropyl group, a 2-ethylpropyl group, a 1,1-dimethylpropyl group, a 1,2-dimethylpropyl group, a 2,2-dimethylpropyl group, a n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, a straight chain or branched chain heptyl group, and a straight chain or branched chain octyl group. Examples of the alkyl groups with carbon numbers different from the above are those with the corresponding carbon numbers among the above alkyl groups.

The alkoxy groups each are an unsubstituted straight chain or branched chain alkoxy group unless otherwise stated. Examples of the alkoxy group with a carbon number of at least 1 and no greater than 6 include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group. Examples of the alkoxy groups with carbon numbers different from the above are those with the corresponding carbon numbers among the above alkoxy groups. The substituents used in the present specification have been described so far.

### EXAMPLES

The following describes the present disclosure further specifically using examples. However, the present disclosure is not limited to the scope of the examples.

### [Polyarylate Resin Synthesis]

Polyarylate resins (PA-1) to (PA-10) were synthesized by the following methods. Monomers used for the synthesis of the polyarylate resins are represented by chemical formulas (BisCZ), (BisB), (DHPE), (BisBP), (OBBOC), (1,4-NADOC), (2,6-NADOC), and (TPC) (also referred to below as compounds (BisCZ), (BisB), (DHPE), (BisBP), (OBBOC), (1,4-NADOC), (2,6-NADOC), and (TPC), respectively).

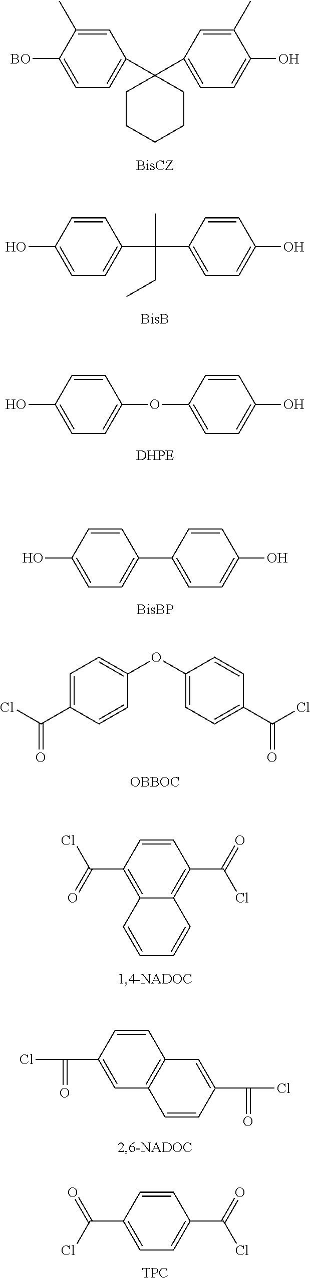

A three-neck flask equipped with a thermometer, a three-way cock, and a dropping funnel was used as a reaction vessel. The reaction vessel was charged with the compound (BisCZ) (32.8 mmol), the compound (DHPE) (8.2 mmol), 2,6-dimethylphenol (0.413 mmol) being a terminator, sodium hydroxide (98 mmol), and benzyltributylammonium chloride (0.384 mmol). The air in the reaction vessel was replaced with an argon gas. Water (300 mL) was added to the contents of the reaction vessel. The contents of the reaction vessel was stirred at 50° C. for 1 hour. The contents of the reaction vessel was cooled to 10° C. to obtain an alkaline aqueous solution S-A. Of the bisphenol compounds contained in the alkaline aqueous solution S-A, the compound (BisCZ) had a percentage content of 80.0% by mole and the compound (DHPE) had a percentage content of 20.0% by mole.

Next, the compound (OBBOC) (20.8 mmol) and the compound (TPC) (11.2 mmol) were dissolved in chloroform (150 mL). Thus, a chloroform solution S-B was obtained. Of the carboxylic acid dichlorides contained in the chloroform solution S-B, the compound (OBBOC) had a percentage content of 65.0% by mole and the compound (TPC) had a percentage content of 35.0% by mole.

The chloroform solution S-B was gradually dripped into the alkaline aqueous solution S-A over 110 minutes using a dropping funnel. The contents of the reaction vessel was stirred for 4 hours to allow polymerization reaction to proceed while the temperature (liquid temperature) of the contents of the reaction vessel was adjusted to 15±5° C. The upper layer (water layer) in the contents of the reaction vessel was removed by decantation. Next, ion exchange water (400 mL) was added into a conical flask. The obtained organic layer was additionally added into the conical flask. Chloroform (400 mL) and acetic acid (2 mL) were additionally added into the conical flask. The contents of the conical flask were stirred at room temperature (25° C.) for 30 minutes. The upper layer (water layer) in the contents of the conical flask was removed by decantation to obtain an organic layer. The obtained organic layer was washed with ion exchange water (1 L) using a separatory funnel. The washing with ion exchange water was repeated 5 times to obtain a washed organic layer. Next, the washed organic layer was filtered to obtain filtrate. The resulting filtrate was gradually dripped into methanol (1 L) to obtain precipitate. The precipitate was taken out by filtration. The taken precipitate was vacuum dried at a temperature of 70° C. for 12 hours. As a result, the polyarylate resin (PA-1) was obtained.

The polyarylate resins (PA-2) to (PA-10) were synthesized according to the same method as that for synthesizing the polyarylate resin (PA-1) in all aspects except for use of the monomers of the types and in amount shown in Table 3. Note that the total amount of the bisphenol compounds was set to 41.0 mmol and the total amount of the dicarboxylic acid dichlorides was set to 32.0 mmol in the synthesis of each of the polyarylate resins (PA-2) to (PA-10). In Table 3, “%” indicates percentage by mole. In Table 3, “Rate (3)” and “Rate (4)” refer to the rate (3) and the rate (4), respectively.

The ¹H-NMR spectrum of each of the resulting polyarylate resins (PA-1) to (PA-10) was plotted using a proton nuclear magnetic resonance spectrometer produced by JEOL Ltd. (600 MHz). The solvent used was deuterated chloroform. The internal standard sample used was tetramethylsilane (TMS). From the chemical shifts read from the ¹H-NMR spectra, it was confirmed that the polyarylate resins (PA-1) to (PA-10) respectively included repeating units represented by chemical formulas (pa-1) to (pa-10). With reference to each of the polyarylate resins (PA-1) to (PA-10), the percentage content of the repeating units derived from the bisphenol compounds was approximately 50.0% by mole to all repeating units included in the resin and the percentage content of the repeating units derived from the dicarboxylic acid dichlorides was approximately 50% by mole thereto. Of the polyarylate resins (PA-1) to (PA-10), the polyarylate resins (PA-1) to (PA-4) each were the specific polyarylate resin.

TABLE 3

| | Bisphenol compound | | | | Dicarboxylic acid dichloride | | | | | |
|---|---|---|---|---|---|---|---|---|---|---|
| | First | | Third | | Second | | Fourth | | Rate (3) | Rate (4) |
| | Type | % | Type | % | Type | % | Type | % | [%] | [%] |
| PA-1 | BisCZ | 80.0 | DHPE | 20.0 | OBBOC | 65.0 | TPC | 35.0 | 20.0 | 35.0 |
| PA-2 | BisCZ | 60.0 | DHPE | 40.0 | OBBOC | 65.0 | TPC | 35.0 | 40.0 | 35.0 |
| PA-3 | BisCZ | 80.0 | DHPE | 20.0 | OBBOC | 35.0 | TPC | 65.0 | 20.0 | 65.0 |
| PA-4 | BisB | 80.0 | DHPE | 20.0 | OBBOC | 65.0 | TPC | 35.0 | 20.0 | 35.0 |
| PA-5 | BisCZ | 95.0 | BisBP | 5.0 | 1,4-NADOC | 50.0 | 2,6-NADOC | 50.0 | — | — |
| PA-6 | BisCZ | 80.0 | DHPE | 20.0 | OBBOC | 100.0 | — | — | 20.0 | — |
| PA-7 | BisCZ | 100.0 | — | — | OBBOC | 65.0 | TPC | 35.0 | — | 35.0 |
| PA-8 | BisCZ | 50.0 | DHPE | 50.0 | OBBOC | 65.0 | TPC | 35.0 | 50.0 | 35.0 |
| PA-9 | BisCZ | 80.0 | DHPE | 20.0 | OBBOC | 100.0 | — | — | 20.0 | — |
| PA-10 | BisCZ | 80.0 | DHPE | 20.0 | OBBOC | 25.0 | TPC | 75.0 | 20.0 | 75.0 |

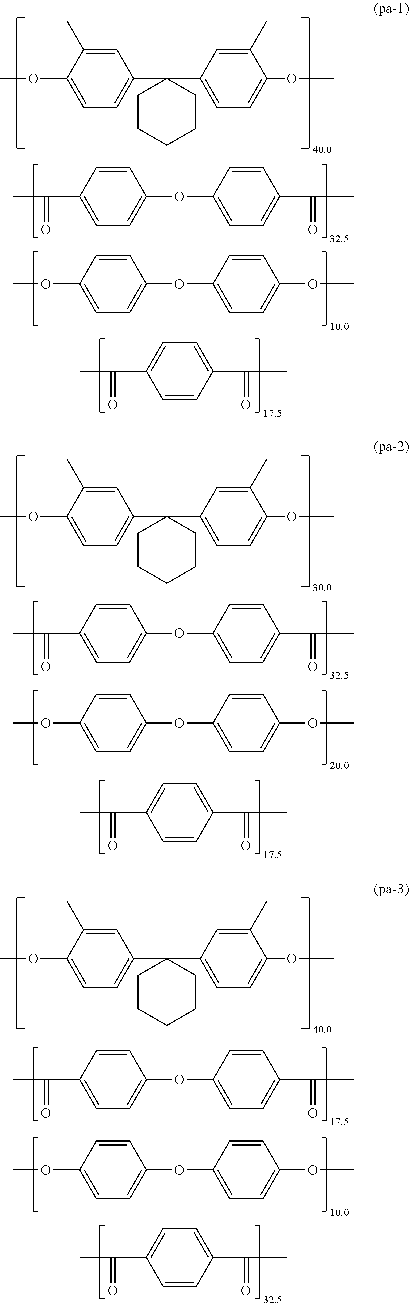

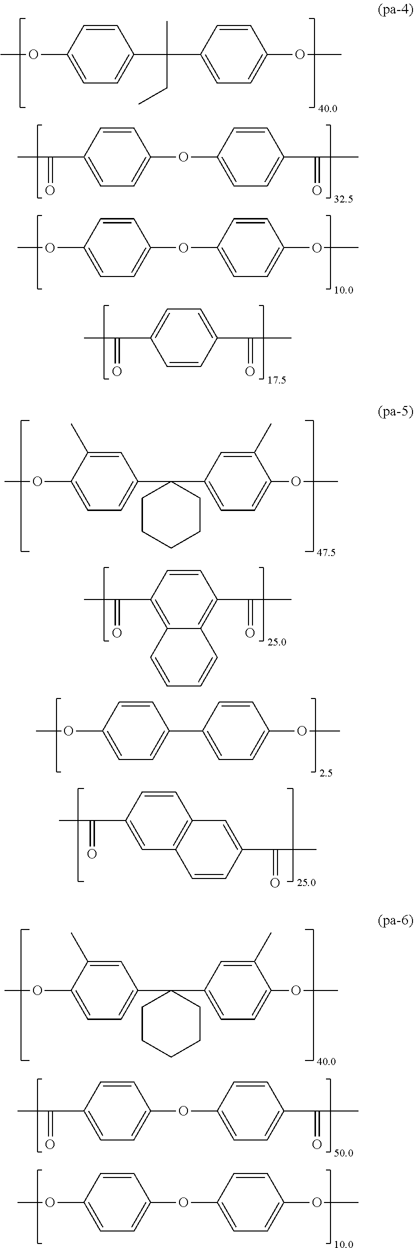

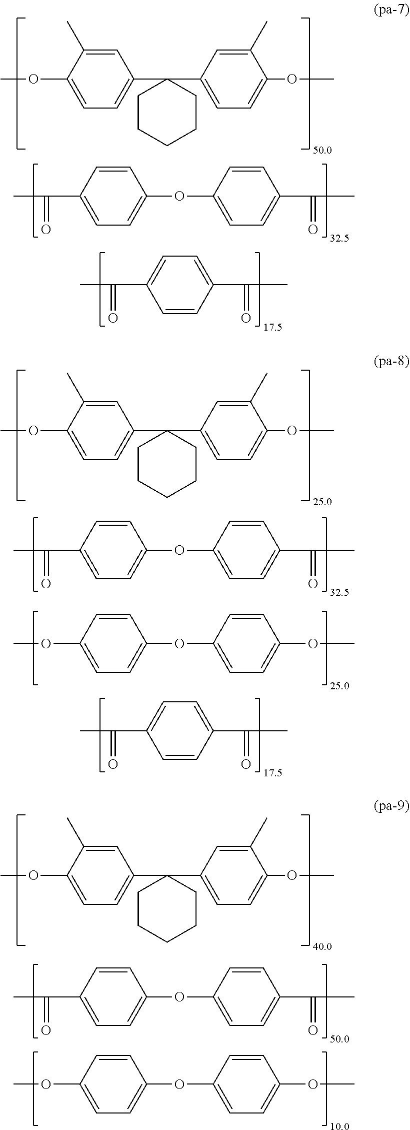

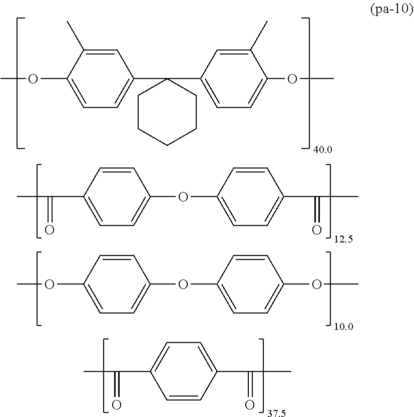

### [Pigments]

Compounds represented by the following chemical formulas (K-1) to (K-5) (also referred to below as pigments (K-1) to (K-5), respectively) were prepared each as a pigment to be added to a charge transport layer. Of the pigments (K-1) to (K-5), the pigments (K-1) and (K-2) each were a phthalocyanine pigment. The pigment (K-1) was Y-form titanyl phthalocyanine. The pigment (K-2) was metal-free phthalocyanine.

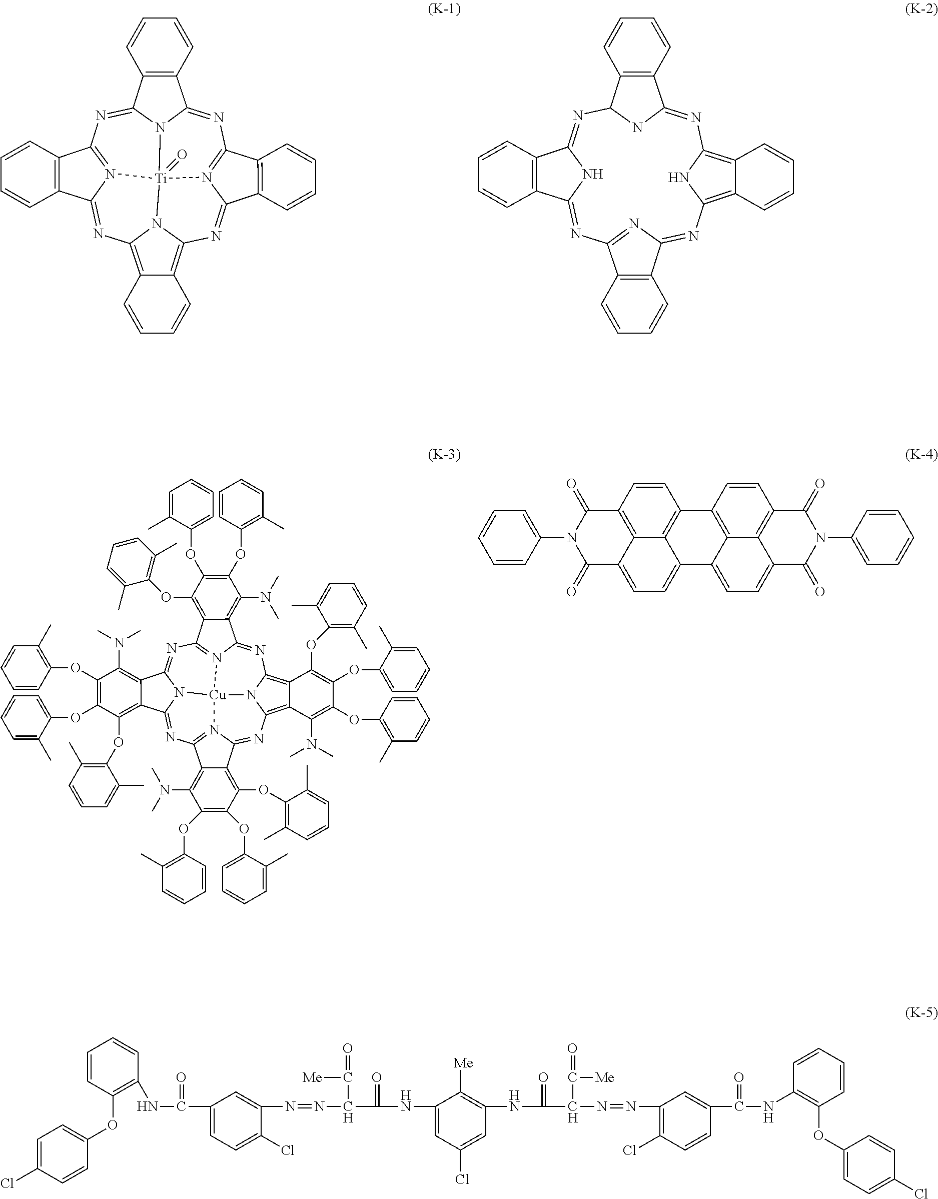

### <Photosensitive Member Production>

The following method was employed for production of photosensitive members of Examples 1 to 13 and Comparative Examples 1 to 18 each being a photosensitive member including a negatively chargeable multi-layer photosensitive layer.

### Example 1

### (Intermediate Layer Formation)

The metal oxide particles used were “SMT-A” produced by TAYCA CORPORATION. The metal oxide particles were particles (number average primary particle diameter 10 nm) sequentially subjected to primary surface treatment using alumina and silica and secondary surface treatment using methyl hydrogen polysiloxane. Mixing was performed of 2 parts by mass of the metal oxide particles, 1 part by mass of a polyamide resin (“AMILAN (registered Japanese trademark) CM8000”, product of Toray Industries, Inc., copolymer of nylon 6, nylon 12, nylon 66, and nylon 610), 10 parts by mass of methanol, 1 part by mass of n-butanol, and 1 part by mass of toluene. The resulting mixed liquid was stirred for 5 hours using a bead mill to sufficiently disperse the metal oxide particles in the solvent (mixed organic solvent of methanol, n-butanol, and toluene). The mixed liquid after the dispersion was filtered using a filter with a pore diameter of 5 μm. Through the above, an application liquid for intermediate layer formation was prepared.

The conductive substrate used was an aluminum drum-shaped support (diameter 30 mm). The application liquid for intermediate layer formation was applied onto the conductive substrate by dip coating. Next, the conductive substrate after the application was dried by heating at 130° C. for 30 minutes. Through the above, an intermediate layer (film thickness: 1.5 μm) was formed on the conductive substrate.

### (Charge Generating Layer Formation)

A mixed liquid was obtained by mixing 2.3 parts by mass of Y-form titanyl phthalocyanine, 1.0 part by mass of polyvinyl acetal resin (“S-LEC (registered Japanese trademark) BX-5”, product of SEKISUI CHEMICAL CO., LTD.) as the base resin, 40.0 parts by mass of propylene glycol monomethyl ether, and 40.0 parts by mass of tetrahydrofuran. The resulting mixed liquid underwent dispersion treatment for 12 hours using a bead mill. The mixed liquid after the dispersion treatment was filtered using a filter with a pore diameter of 3 μm. Through the above, an application liquid for charge generating layer formation was obtained. Next, the application liquid for charge generating layer formation was applied onto the intermediate layer by dip coating. The applied application liquid for charge generating layer formation was dried at 50° C. for 5 minutes to form a charge generating layer (film thickness: 0.3 μm) on the intermediate layer.

### (Charge Transport Layer Formation)

An application liquid for charge transport layer formation was obtained by mixing 45.0 parts by mass of the hole transport material (H-1), 100.0 parts by mass of the polyarylate resin (PA-1) as the binder resin, 0.1 parts by mass of the pigment (K-1), 0.05 parts by mass of a silicone oil (“KF96-50CS”, product of Shin-Etsu Chemical Co., Ltd., dimethyl silicone oil), 560.0 parts by mass of tetrahydrofuran, and 140.0 parts by mass of toluene. Next, the application liquid for charge transport layer formation was applied onto the charge generating layer by dip coating. The applied application liquid for charge transport layer formation was dried at 120° C. for 40 minutes to form a charge transport layer (film thickness: 20 μm) on the charge generating layer. Thus, the photosensitive member of Example 1 was obtained.

### Examples 2 to 13 and Comparative Examples 1 to 18

The photosensitive members of Examples 2 to 13 and Comparative Examples 1 to 18 were produced according to the same method as that for producing the photosensitive member of Example 1 in all aspects other than the following changes. In the production of the photosensitive members of Examples 2 to 13 and Comparative Examples 1 to 18, the types of the polyarylate resin and the hole transport material used for charge transport layer formation and the type and amount of the pigment were changed to those shown in Table 4. However, the photosensitive member was not produced in the production of the photosensitive member of Comparative Example 16 because the application liquid for charge transport layer formation was galled. In the production of the photosensitive member of Comparative Example 18, the application liquid for charge transport layer formation became cloudy although the photosensitive member was produced.

TABLE 4

| | Polyarylate | Hole transport | Pigment | |
|---|---|---|---|---|
| | resin | material | Type | Part by mass |
| Example 1 | PA-1 | H-1 | K-1 | 0.1 |
| Example 2 | PA-1 | H-1 | K-1 | 0.3 |
| Example 3 | PA-1 | H-1 | K-1 | 0.5 |
| Example 4 | PA-1 | H-1 | K-2 | 0.3 |
| Example 5 | PA-1 | H-2 | K-1 | 0.3 |
| Example 6 | PA-1 | H-3 | K-1 | 0.3 |
| Example 7 | PA-1 | H-4 | K-1 | 0.3 |
| Example 8 | PA-1 | H-5 | K-1 | 0.3 |
| Example 9 | PA-1 | H-6 Mixture | K-1 | 0.3 |
| Example 10 | PA-1 | H-7 | K-1 | 0.3 |
| Example 11 | PA-2 | H-1 | K-1 | 0.3 |
| Example 12 | PA-3 | H-1 | K-1 | 0.3 |
| Example 13 | PA-4 | H-1 | K-1 | 0.3 |
| Comparative | PA-1 | H-1 | — | — |
| Example 1 | | | | |
| Comparative | PA-1 | H-1 | K-3 | 0.3 |
| Example 2 | | | | |
| Comparative | PA-1 | H-1 | K-4 | 0.3 |
| Example 3 | | | | |
| Comparative | PA-1 | H-1 | K-5 | 0.3 |
| Example 4 | | | | |
| Comparative | PA-5 | H-1 | — | — |
| Example 5 | | | | |
| Comparative | PA-5 | H-1 | K-1 | 0.3 |
| Example 6 | | | | |
| Comparative | PA-5 | H-1 | K-3 | 0.3 |
| Example 7 | | | | |
| Comparative | PA-5 | H-1 | K-4 | 0.3 |
| Example 8 | | | | |
| Comparative | PA-5 | H-1 | K-5 | 0.3 |
| Example 9 | | | | |
| Comparative | PA-6 | H-1 | — | — |
| Example 10 | | | | |
| Comparative | PA-6 | H-1 | K-1 | 0.3 |
| Example 11 | | | | |
| Comparative | PA-6 | H-1 | K-3 | 0.3 |
| Example 12 | | | | |
| Comparative | PA-6 | H-1 | K-4 | 0.3 |
| Example 13 | | | | |
| Comparative | PA-6 | H-1 | K-5 | 0.3 |
| Example 14 | | | | |
| Comparative | PA-7 | H-1 | K-1 | 0.3 |
| Example 15 | | | | |
| Comparative | PA-8 | H-1 | K-1 | 0.3 |
| Example 16 | | | | |
| Comparative | PA-9 | H-1 | K-1 | 0.3 |
| Example 17 | | | | |
| Comparative | PA-10 | H-1 | K-1 | 0.3 |
| Example 18 | | | | |

### <Evaluation>

Sensitivity characteristics, abrasion resistance and preservability, occurrence or non-occurrence of image memory and fogging of each of the photosensitive members of Examples 1 to 13 and Comparative Examples 1 to 18 were evaluated by the following methods. Evaluation results are shown in Table 5.

### [Sensitivity Characteristics]

Sensitivity characteristics were evaluated in an environment at a temperature of 23° C. and a relative humidity of 50% using a photosensitive member electrical property testing apparatus produced by Gentec Inc. In the evaluation of sensitivity characteristics, two types of sensitivity characteristics (sensitivity characteristics A and B) were evaluated. Photosensitive members that have passed both sensitivity characteristics A and B were determined to be excellent in sensitivity characteristics. By contrast, photosensitive members that have failed at least one of sensitivity characteristics A and B were determined to be insufficient in sensitivity characteristics. Note that sensitivity characteristic B corresponds to the exposure conditions when expressing halftones. Therefore, a photosensitive member that has passed sensitivity characteristics B is determined to be excellent in expression of halftones.

### (Sensitivity Characteristics A)

Using the aforementioned apparatus, the photosensitive member was charged to have a surface potential of −500V (charge potential). Next, the surface of the photosensitive member was irradiated with exposure light (wavelength 780 nm, exposure light quantity 0.30 μJ/cm²) using the aforementioned apparatus. Next, the surface potential (post-exposure potential A) of the photosensitive member was measured after 77 milliseconds have elapsed after the light exposure. The measured post-exposure potential A was used as a measurement value for sensitivity characteristics A. Sensitivity characteristics A was evaluated according to the following criteria.

### (Criteria of Sensitivity Characteristics A)

A (pass): absolute value of post-exposure potential A of no greater than 100 V
B (failed): absolute value of post-exposure potential A of greater than 100 V

### (Sensitivity Characteristics B)

Using the aforementioned apparatus, the photosensitive member was charged to have a surface potential of −500V (charge potential). Next, the surface of the photosensitive member was irradiated with exposure light (wavelength 780 nm, exposure light quantity 0.15 μJ/cm²) using the aforementioned apparatus. Next, the surface potential (post-exposure potential B) of the photosensitive member was measured after 77 milliseconds have elapsed after the light exposure. The measured post-exposure potential B was used as a measurement value for sensitivity characteristics B. Sensitivity characteristics B was evaluated according to the following criteria.

### (Criteria of Sensitivity Characteristics B)

A (pass): absolute value of post-exposure potential B of no greater than 250 V
B (failed): absolute value of post-exposure potential B of greater than 250 V

### [Abrasion Resistance]

In the evaluation of abrasion resistance, a color printer (“C844DNW”, product of Oki Electric Industry Co., Ltd.) was used as an evaluation apparatus. A cyan toner was loaded into a toner cartridge of the evaluation apparatus. First, a film thickness T1 of the charge transport layer of the photosensitive member being an evaluation target was measured. Next, the photosensitive member being the evaluation target was mounted in a cartridge for cyan color and the cartridge for cyan color was mounted in the evaluation apparatus. Next, an image I (pattern image with a printing rate 1%) was printed on 4000 sheets of paper in a normal-temperature and normal-humidity environment (temperature 23° C. and relative humidity of 50%) using the evaluation apparatus. Next, the image I was printed on 4000 sheets of paper in a high-temperature and high-humidity environment (temperature 32° C. and relative humidity of 85%, also referred to below as HH environment) using the evaluation apparatus. Next, the image I was printed on 4000 sheets of paper in a low-temperature and low-humidity environment (temperature 10° C. and relative humidity of 15%, also referred to below as LL environment) using the evaluation apparatus. After the printing in the LL environment, the evaluation apparatus was left to stand for 2 hours. Next, a solid image (image with an image density of 100%) was printed on one sheet of paper in the LL environment using the evaluation apparatus. Thereafter, the photosensitive member being the evaluation target was taken out of the evaluation apparatus. Thereafter, a film thickness T2 of the charge transport layer of the photosensitive member being the evaluation target was measured. Then, an abrasion amount (T1−T2, unit: μm) was obtained which corresponds to the amount of change in thickness of the charge transport layer between before and after the printing. From the abrasion amount, abrasion resistance of the photosensitive member was evaluated according to the following criteria.

### (Criteria of Abrasion Resistance)

A (good): abrasion amount of no greater than 2.0 m
B (poor): abrasion amount of greater than 2.0 m

### [Image Memory]

In the evaluation of image memory, a color printer (“C844DNW”, product of Oki Electric Industry Co., Ltd.) was used as an evaluation apparatus. A cyan toner was loaded into a toner cartridge of the evaluation apparatus. The photosensitive member being an evaluation target was mounted in the cartridge for cyan color, and the cartridge for cyan color was mounted in the evaluation apparatus. Next, for the evaluation apparatus, the printing medium type (recording medium) was set to thick paper and the sheet feeding direction was set to vertical feed. Next, a cyan solid image was printed on 100 sheets of A4-size recording medium (“LASER PEACH WETY-145”, product of Oji Paper Co., Ltd.) using the evaluation apparatus. Next, a cyan halftone image (image density 50%) was printed on a sheet of the A3-size plain paper. The halftone image printed on the sheet of the A3-size plain paper was used as an evaluation image. In the cyan solid image printing, the sheet passing area of the photosensitive member where the A4-size recording medium sheet passes indirectly receives damage (charge accumulation in charge transport layer) caused by transfer via the recording medium sheet. By contrast, the sheet non-passing area of the photosensitive member where the A4-size recording medium sheet did not pass directly receives damage caused by transfer. Therefore, density difference may arise in the evaluation image between an image (image corresponding to the sheet passing area) of a part of the evaluation image formed through the sheet passing area of the photosensitive member and an image (image corresponding to the sheet non-passing area) of a part of the evaluation image formed through the sheet non-passing area. Specifically, the image corresponding to the sheet non-passing area may be higher in image density than the image corresponding to the sheet passing area. In the evaluation of image memory, the density difference between the image corresponding to the sheet passing area and the image corresponding to the image non-passing area was compared visually. Photosensitive members with less density difference are evaluated to be able to inhibit occurrence of image memory. Image memory was evaluated according to the following criteria.

### (Criteria of Image Memory)

Particularly good (A): no image density difference recognized between image corresponding to sheet passing area and image corresponding to sheet non-passing area
Good (B): slight image density difference recognized between image corresponding to sheet passing area and image corresponding to sheet non-passing area
Poor (C): apparent image density difference recognized between image corresponding to sheet passing area and image corresponding to sheet non-passing area

### [Fogging]

In the evaluation of fogging, a color printer (“C844DNW”, product of Oki Electric Industry Co., Ltd.) was used as an evaluation apparatus. A cyan toner was loaded into a toner cartridge of the evaluation apparatus. The photosensitive member being an evaluation target was mounted in the cartridge for cyan color, and the cartridge for cyan color was mounted in the evaluation apparatus. An image I (pattern image with a printing rate 1%) was printed on 2000 sheets of paper in an HH environment at a temperature of 32° C. and a relative humidity of 85% using the evaluation apparatus. Next, the evaluation apparatus was left to stand for 12 hours in the HH environment. Next, a blank image was printed on one sheet of paper in the HH environment. Next, the photosensitive member was taken out of the evaluation apparatus. Next, toner attached to the surface of the photosensitive member was collected using tape (“SCOTCH (registered Japanese trademark) MENDING TAPE”, product of 3M Japan Limited). Next, the image density of the tape was measured using a fluorescence spectrodensitometer (“FD-5”, product of KONICA MINOLTA, INC.). Fogging was evaluated according to the following criteria.

### (Criteria of Fogging)

A (particularly good): image density of no greater than 1.3
B (good): image density of greater than 1.3 and no greater than 1.6
C (poor): image density of greater than 1.6

### [Preservability]

The photosensitive member being an evaluation target was mounted in an image drum (“DR-C3BC”, product of Oki Electric Industry Co., Ltd.). Thereafter, a charging roller of the image drum was allowed to contact with a given area of the circumferential surface of the photosensitive member. In the following, the given area of the circumferential surface of the photosensitive member that has contacted with the charging roller may be also referred to below as “member contact area”. Also, an area of the photosensitive member other than the member contact area may be also referred to below as “member non-contact area”. The image drum with the photosensitive member mounted therein was left to stand in an environment at a temperature of 50° C. and a relative humidity of 85% for 4 weeks. After the leaving to stand for 4 weeks, the image drum with the photosensitive member mounted therein was mounted in the aforementioned evaluation apparatus. Next, an image (cyan halftone image with a printing rate of 50%) was printed on one sheet of paper using the evaluation apparatus. The image was used as an evaluation image. Note that in the member contact area of the photosensitive member, the charge transport layer receives pressure by contact with the charging roller and components bleeding out of the charging roller attaches to the surface of the charge transport layer. As a result, the image density of an image (image A) formed by the member contact area of the photosensitive member may be higher than that of an image (image B) formed by the member non-contact area thereof. However, such a difference in image density is hardly observed in images formed using a photosensitive member excellent in preservability. In the evaluation of preservability of the photosensitive member, the difference in image density between the images A and B was visually compared. Photosensitive members with less difference in image density are determined to be excellent in preservability. Preservability of the photosensitive member was evaluated according to the following criteria.

### (Criterial of Preservability)

A (particularly good): no difference in image density recognized between images A and B
B (good) slight difference in image density recognized between images A and B
C (poor) apparent difference in image density recognized between images A and B

TABLE 5

| | | | | Abrasion resistance | | | | | |
|---|---|---|---|---|---|---|---|---|---|
| | Sensitivity characteristics | | | Abrasion | | | Fogging | | |
| | Characteristics | Characteristics | | amount | | Image | Image | | Pre- |
| | A [V] | B [V] | Rating | [μm] | Rating | memory | density | Rating | servability |
| Example 1 | 45 | 138 | A | 1.2 | A | A | 1.0 | A | A |
| Example 2 | 51 | 166 | A | 1.2 | A | A | 1.2 | A | A |
| Example 3 | 85 | 226 | A | 1.3 | A | A | 1.2 | A | A |
| Example 4 | 60 | 201 | A | 1.2 | A | A | 1.2 | A | A |
| Example 5 | 44 | 120 | A | 1.1 | A | B | 1.4 | B | A |
| Example 6 | 45 | 132 | A | 1.1 | A | B | 1.6 | B | A |
| Example 7 | 41 | 125 | A | 1.0 | A | B | 1.4 | B | A |
| Example 8 | 40 | 120 | A | 0.9 | A | B | 1.5 | B | A |
| Example 9 | 52 | 140 | A | 1.4 | A | B | 1.3 | A | A |
| Example 10 | 79 | 141 | A | 1.0 | A | A | 1.3 | A | A |
| Example 11 | 49 | 159 | A | 1.0 | A | A | 1.2 | A | A |
| Example 12 | 52 | 161 | A | 1.9 | A | A | 1.3 | A | A |
| Example 13 | 48 | 155 | A | 0.9 | A | A | 1.4 | B | B |
| Comparative Example 1 | 45 | 116 | A | 1.2 | A | C | 1.8 | C | A |
| Comparative Example 2 | 55 | 145 | A | 1.2 | A | C | 1.4 | B | A |
| Comparative Example 3 | 58 | 160 | A | 1.2 | A | C | 1.3 | A | A |
| Comparative Example 4 | 66 | 179 | A | 1.3 | A | C | 1.5 | B | A |
| Comparative Example 5 | 51 | 128 | A | 2.4 | B | C | 1.1 | A | A |
| Comparative Example 6 | 55 | 170 | A | 2.5 | B | B | 0.9 | A | A |
| Comparative Example 7 | 60 | 165 | A | 2.5 | B | C | 1.0 | A | A |
| Comparative Example 8 | 62 | 171 | A | 2.4 | B | C | 1.1 | A | A |
| Comparative Example 9 | 69 | 185 | A | 2.5 | B | C | 1.2 | A | A |
| Comparative Example 10 | 43 | 113 | A | 0.9 | A | C | 2.0 | C | C |
| Comparative Example 11 | 49 | 165 | A | 0.9 | A | B | 1.9 | C | C |
| Comparative Example 12 | 53 | 145 | A | 0.9 | A | C | 1.9 | C | C |
| Comparative Example 13 | 54 | 161 | A | 1.0 | A | C | 1.9 | C | C |
| Comparative Example 14 | 60 | 177 | A | 1.0 | A | C | 1.9 | C | C |
| Comparative Example 15 | 48 | 159 | A | 3.0 | B | A | 1.1 | A | A |
| Comparative Example 16 | Photosensitive member production impossible | | | | | | | | |
| Comparative Example 17 | 55 | 171 | A | 1.1 | A | A | 1.1 | A | C |
| Comparative Example 18 | 60 | 175 | A | 2.9 | B | A | 1.1 | A | A |

As shown in Tables 3 to 5, each of the photosensitive members of Examples 1 to 13 included a conductive substrate and a photosensitive layer indirectly provided on the conductive substrate. The photosensitive layer included a charge generating layer and a charge transport layer. The charge transport layer contained a binder resin, a hole transport material, and a phthalocyanine pigment. The binder resin included a specific polyarylate resin. The specific polyarylate resin included a first repeating unit represented by general formula (1), a second repeating unit represented by chemical formula (2), a third repeating unit represented by chemical formula (3), and a fourth repeating unit represented by chemical formula (4). The rate (3) of the number of moles of the third repeating unit to the total number of moles of the first repeating unit and the third repeating unit was greater than 0.0% by mole and less than 50.0% by mole. The rate (4) of the number of moles of the fourth repeating unit to the total number of moles of the second repeating unit and the fourth repeating unit was at least 30.0% by mole and less than 70.0% by mole. The photosensitive member of Examples 1 to 13 each were excellent in sensitivity characteristics, abrasion resistance, and preservability, and inhibited occurrence of image memory and fogging.

By contrast, the photosensitive member of Comparative Example 1 did not contain a pigment in its charge transport layer. As a result, the photosensitive member of Comparative Example 1 caused image memory and fogging. The photosensitive members of Comparative Examples 2 to 4 each contained a pigment other than a phthalocyanine pigment in their charge transport layers. The photosensitive members of Comparative Examples 2 to 4 inhibited occurrence of fogging compared to the photosensitive member of Comparative Example 1. However, the photosensitive members of Comparative Examples 2 to 4 did not inhibit occurrence of image memory.

The photosensitive members of Comparative Examples 5 to 9 each contained the polyarylate resin (PA-5), which differed from the specific polyarylate resin, as the binder resin of their charge transport layers. Furthermore, the photosensitive members of Comparative Examples 4 and 6 to 9 did not contain a phthalocyanine pigment in their charge transport layers. As a result, the photosensitive members of Comparative Examples 4 and 6 to 9 were rated as poor in abrasion resistance and did not inhibit occurrence of image memory. The photosensitive member of Comparative Example 5 inhibited occurrence of image memory as a result of its charge transport layer containing a phthalocyanine pigment. However, the photosensitive member of Comparative Example 5 was rated as poor in abrasion resistance.

The photosensitive members of Comparative Examples 10 to 14 contained the polyarylate resin (PA-6), which differed from the specific polyarylate resin, as the binder resin of their charge transport layers. Furthermore, the photosensitive members of Comparative Examples 10 and 12 to 14 did not contain a phthalocyanine pigment in their charge transport layers. As a result, the photosensitive members of Comparative Examples 10 and 12 to 14 were rated as poor in preservability and did not inhibit occurrence of image memory and fogging. The photosensitive member of Comparative Example 11 inhibited occurrence of image memory as a result of its charge transport layer containing a phthalocyanine pigment. However, the photosensitive member of Comparative Example 11 was also rated as poor in preservability and did not inhibit occurrence of fogging.

The photosensitive member of Comparative Example 15 contained the polyarylate resin (PA-7), which differed from the specific polyarylate resin, as the binder resin of its charge transport layer. The polyarylate resin (PA-7) did not include the third repeating unit. As a result, the photosensitive member of Comparative Example 15 was rated as poor in abrasion resistance.

The photosensitive member of Comparative Examples 16 contained the polyarylate resin (PA-8), which differed from the specific polyarylate resin, as the binder resin of its charge transport layer. The polyarylate resin (PA-8) had a rate (3) of at least 50.0% by mole. As a result, no photosensitive member was produced in the production of the photosensitive member of Comparative Example 16 due to gelation of the application liquid for charge transport layer formation.

The photosensitive member of Comparative Example 17 contained the polyarylate resin (PA-9), which differed from the specific polyarylate resin, as the binder resin of its charge transport layer. The polyarylate resin (PA-9) did not include the fourth repeating unit. As a result, the photosensitive member of Comparative Example 17 was rated as poor in preservability.

The photosensitive member of Comparative Example 18 contained the polyarylate resin (PA-10), which differed from the specific polyarylate resin, as the binder resin of its charge transport layer. The polyarylate resin (PA-10) had a rate (4) of 70.0% by mole or more. As a result, the photosensitive member of Comparative Example 18 was rated as poor in abrasion resistance.

What is claimed is:

1. An electrophotographic photosensitive member comprising:
a conductive substrate; and
a photosensitive layer provide directly or indirectly on the conductive substrate, wherein
the photosensitive layer includes a charge generating layer and a charge transport layer,
the charge transport layer contains a binder resin, a hole transport material, and a phthalocyanine pigment,
the binder resin includes a specific polyarylate resin,
the specific polyarylate resin includes a first repeating unit represented by following general formula (1), a second repeating unit represented by following chemical formula (2), a third repeating unit represented by following chemical formula (3), and a fourth repeating unit represented by following chemical formula (4),
a rate of a number of moles of the third repeating unit to a total number of moles of the first repeating unit and the third repeating unit is greater than 0.0% by mole and less than 50.0% by mole, and
a rate of a number of moles of the fourth repeating unit to a total number of moles of the second repeating unit and the fourth repeating unit is at least 30.0% by mole and less than 70.0% by mole: 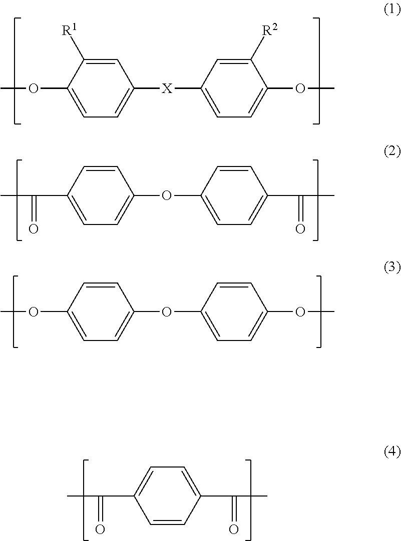
where in the general formula (1), X represents a divalent group with a carbon number of at least 1 and no greater than 10, and R¹ and R² each represent, independently of one another, a hydrogen atom or an alkyl group with a carbon number of at least 1 and no greater than 6.

2. The electrophotographic photosensitive member according to claim 1, wherein
the first repeating unit is represented by following chemical formula (1-1) or (1-2):

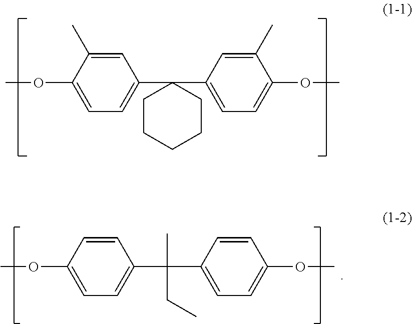

3. The electrophotographic photosensitive member according to claim 1, wherein
the phthalocyanine pigment includes at least one of metal-free phthalocyanine and a compound represented by following general formula (P-1): 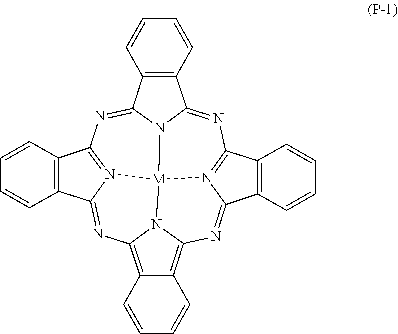
where in the general formula (P-1), M represents a metal atom optionally having a ligand.

4. The electrophotographic photosensitive member according to claim 1, wherein
the phthalocyanine pigment includes titanyl phthalocyanine.

5. The electrophotographic photosensitive member according to claim 1, wherein
the phthalocyanine pigment has a content of at least 0.1 parts by mass and no greater than 0.5 parts by mass relative to 100.0 parts by mass of the binder resin in the charge transport layer.

6. The electrophotographic photosensitive member according to claim 1, wherein
to all repeating units included in the specific polyarylate resin,
the first repeating unit has a percentage content of at least 20.0% by mole and no greater than 45.0% by mole,
the second repeating unit has a percentage content of at least 10.0% by mole and no greater than 40.0% by mole,
the third repeating unit has a percentage content of at least 5.0% by mole and no greater than 30.0% by mole, and
the fourth repeating unit has a percentage content of at least 10.0% by mole and no greater than 40.0% by mole.

7. The electrophotographic photosensitive member according to claim 1, wherein
the specific polyarylate resin includes at least one of resins represented by following chemical formulas (pa-1) to (pa-4):

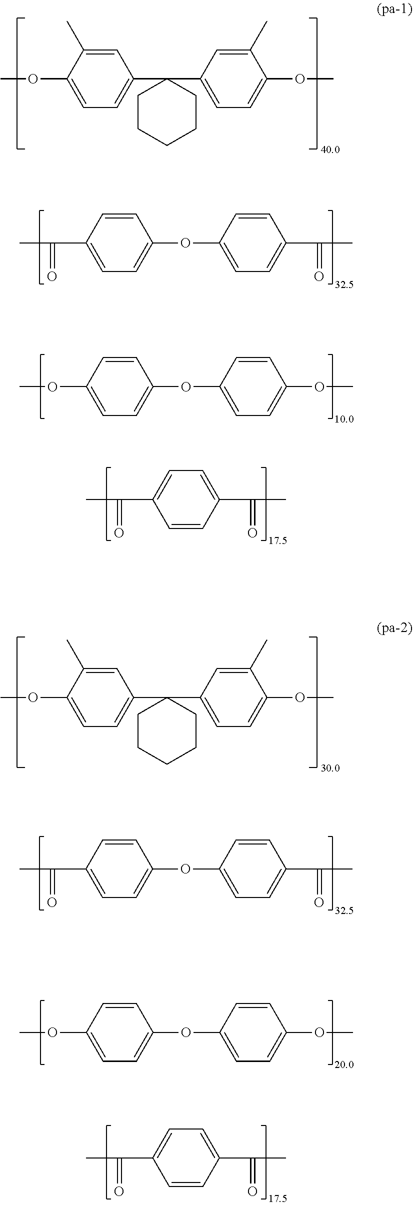

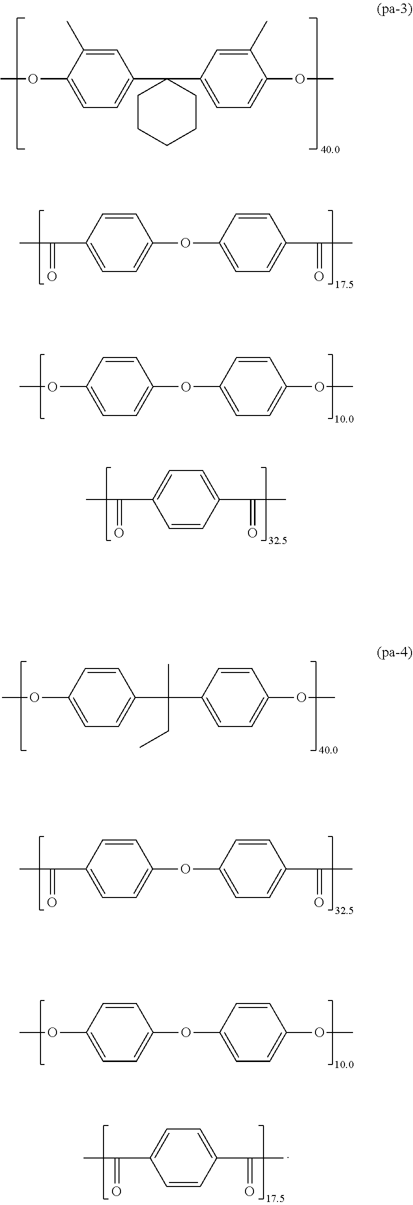

8. The electrophotographic photosensitive member according to claim 1, wherein
the charge transport layer serves as an outermost surface layer.

9. The electrophotographic photosensitive member according to claim 1, wherein
the hole transport material contains at least one of compounds represented by following general formulas (20), (23), (24), and (25): 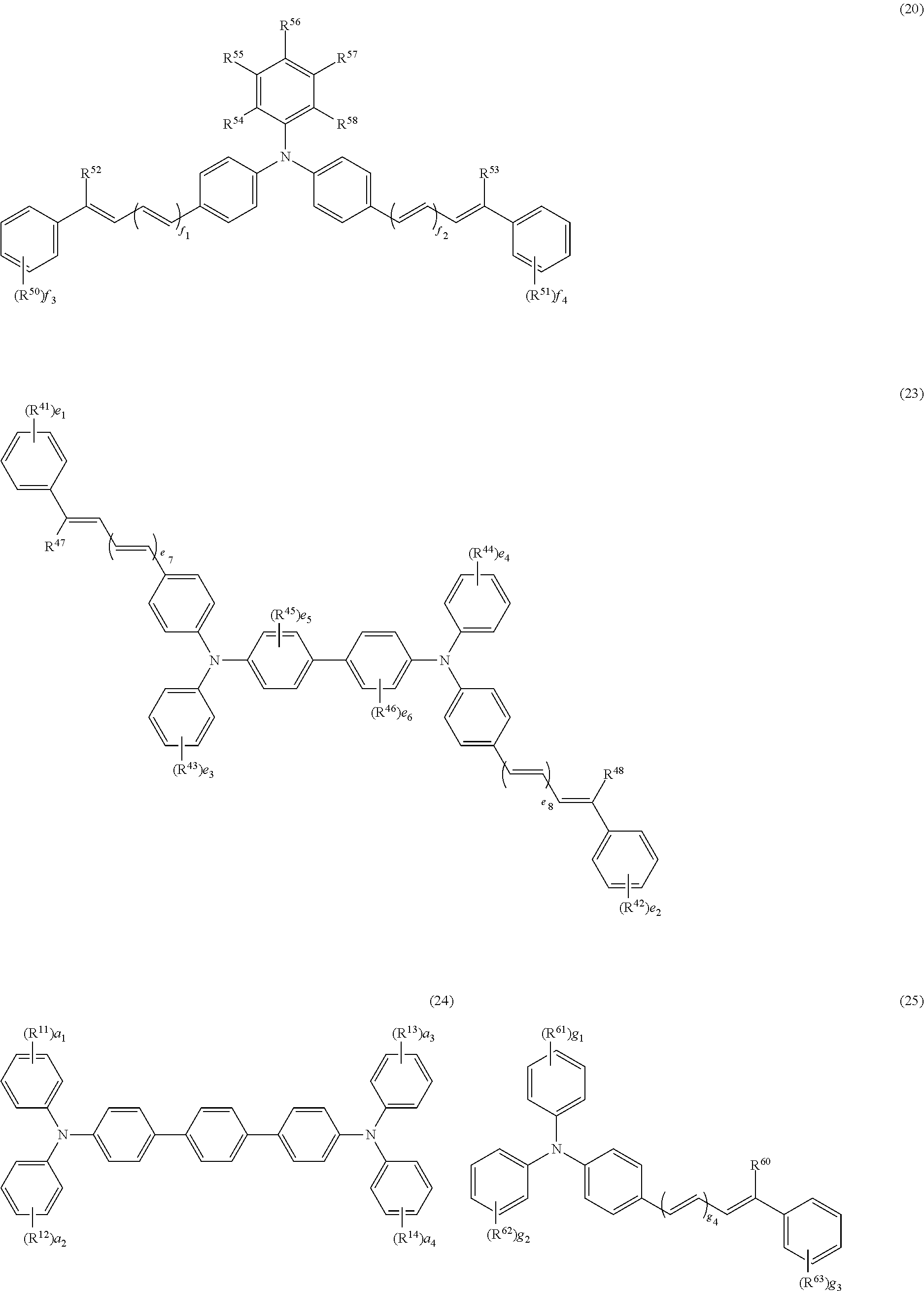
where in the general formula (20):
R⁵⁰ and R⁵¹ each represent, independently of one another, a phenyl group, an alkyl group with a carbon number of at least 1 and no greater than 6, or an alkoxy group with a carbon number of at least 1 and no greater than 6;
R⁵², R⁵³, R⁵⁴, R⁵⁵, R⁵⁶, R⁵⁷, and R⁵⁸ each represent, independently of one another, a hydrogen atom, a phenyl group optionally substituted with an alkyl group with a carbon number of at least 1 and no greater than 6, an alkyl group with a carbon number of at least 1 and no greater than 6, or an alkoxy group with a carbon number of at least 1 and no greater than 6;
f₁ and f₂ each represent, independently of one another, an integer of at least 0 and no greater than 2; and
f₃ and f₄ each represent, independently of one another, an integer of at least 0 and no greater than 5,
where in the general formula (23):
R⁴¹, R⁴², R⁴³, R⁴⁴, R⁴⁵, and R⁴⁶ each represent, independently of one another, a phenyl group or an alkyl group with a carbon number of at least 1 and no greater than 6;
R⁴⁷ and R⁴⁸ each represent, independently of one another, a hydrogen atom, a phenyl group, or an alkyl group with a carbon number of at least 1 and no greater than 6;
e₁, e₂, e₃, and e₄ each represent, independently of one another, an integer of at least 0 and no greater than 5;
e₅ and e₆ each represent, independently of one another, an integer of at least 0 and no greater than 4; and
e₇ and e₈ each represent, independently of one another, 0 or 1,
where in the general formula (24):
R¹¹, R¹², R¹³, and R¹⁴ each represent, independently of one another, an alkyl group with a carbon number of at least 1 and no greater than 6 or an alkoxy group with a carbon number of at least 1 and no greater than 6; and
a₁, a₂, a₃, and a₄ each represent, independently of one another, an integer of at least 0 and no greater than 5, and
where in the general formula (25):
R⁶⁰ represents a hydrogen atom, a phenyl group optionally substituted with an alkyl group with a carbon number of at least 1 and no greater than 8, an alkyl group with a carbon number of at least 1 and no greater than 8, or an alkoxy group with a carbon number of at least 1 and no greater than 8;
R⁶¹, R⁶², and R⁶³ each represent, independently of one another, an alkyl group with a carbon number of at least 1 and no greater than 8 or an alkoxy group with a carbon number of at least 1 and no greater than 8;
g1, g2, and g3 each represent, independently of one another, an integer of at least 0 and no greater than 5; and
g4 represents 0 or 1.

10. The electrophotographic photosensitive member according to claim 9, wherein
the hole transport material includes at least one of compounds represented by following chemical formulas (H-1) to (H-5), general formula (H-6), and chemical formula (H-7): 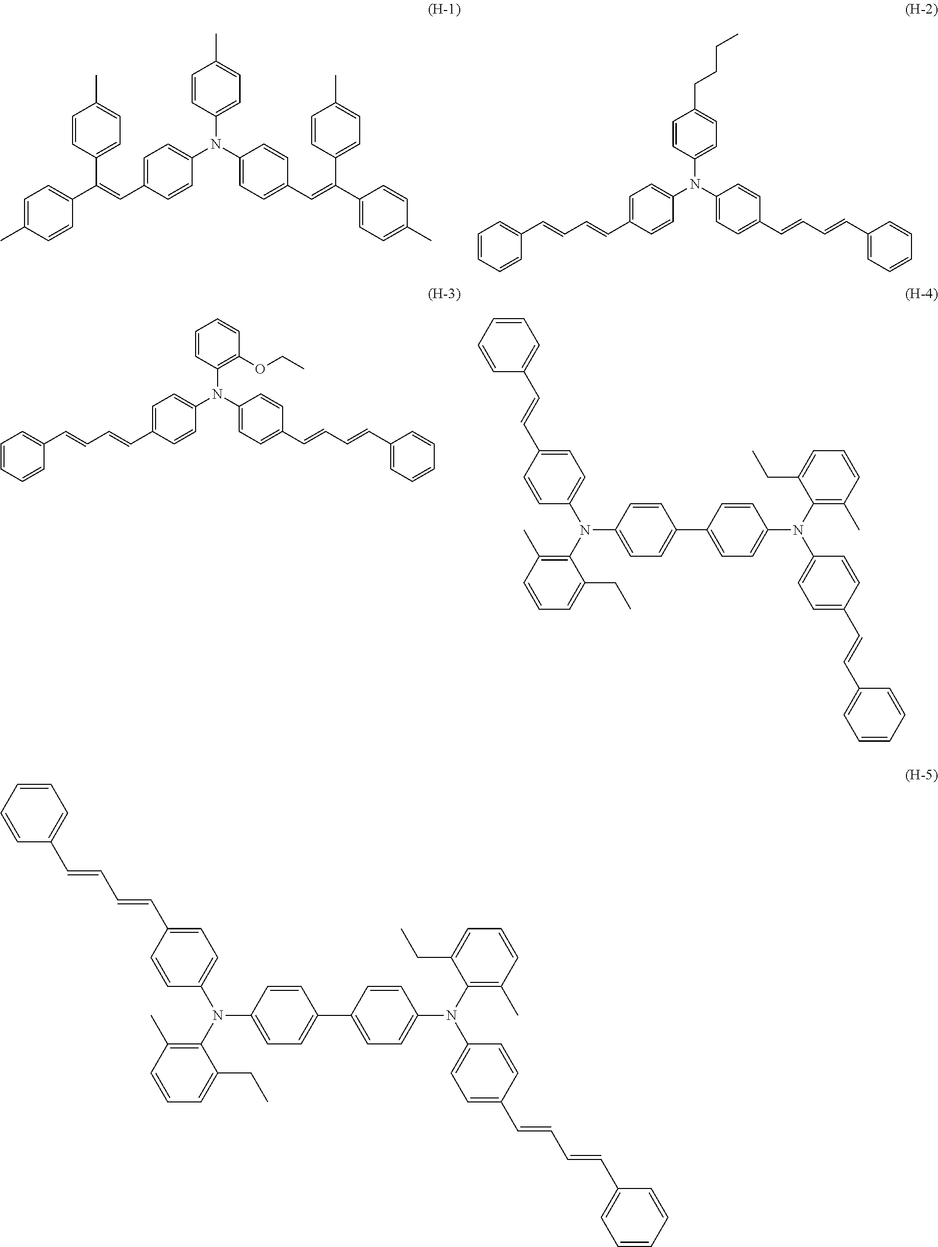 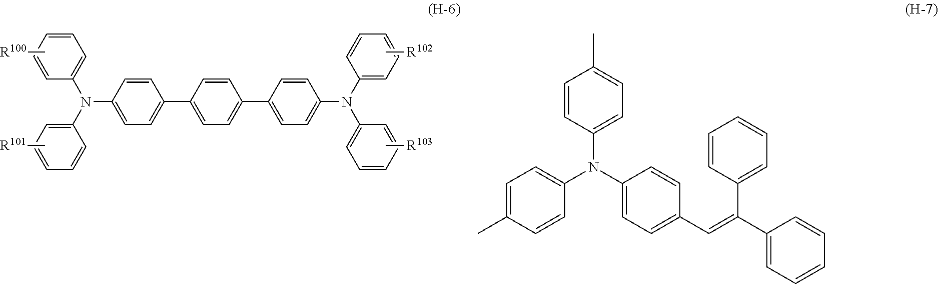
where in the general formula (H-6), R¹⁰⁰ to R¹⁰³ each represent, independently of one another, a hydrogen atom or a methyl group, and
at least two of R¹⁰⁰ to R¹⁰³ each represent a methyl group.

11. The electrophotographic photosensitive member according to claim 1, wherein
the charge generating layer contains a charge generating material and a base resin.

12. The electrophotographic photosensitive member according to claim 11, wherein
the charge generating material includes Y-form titanyl phthalocyanine.

13. A process cartridge comprising
the electrophotographic photosensitive member according to claim 1.

14. An image forming apparatus comprising:
an image bearing member:
a charger that charges a surface of the image bearing member;
a light exposure device that exposes the charged surface of the image bearing member to light to form an electrostatic latent image on the surface of the image bearing member;
a development device that develops the electrostatic latent image into a toner image by supplying toner to the surface of the image bearing member; and
a transfer device that transfers the toner image from the image bearing member to a transfer target, wherein
the image bearing member is the electrophotographic photosensitive member according to claim 1.

15. The image forming apparatus according to claim 14, wherein
the transfer device adopts a direct transfer process, and
the transfer target is a recording medium.
